(19) United States
(12) Patent Application Publication
(10) Pub. No.: US 2026/0153349 A1
(43) Pub. Date: Jun. 4, 2026

(54) SYSTEM AND METHOD FOR DISPLAYING AND VALIDATING REAL-TIME LOCAL RESTAURANT PROMOTIONS WITH AN INTERACTIVE MAP AND CAROUSEL INTERFACE

(71) Applicant: Theodore Hoxie, Dover, NH (US)

(72) Inventor: Theodore Hoxie, Dover, NH (US)

(21) Appl. No.: 19/409,667

(22) Filed: Dec. 4, 2025

Related U.S. Application Data
(60) Provisional application No. 63/727,678, filed on Dec. 4, 2024.

(51) Int. Cl. G01C 21/36; G01C 21/34; G06Q 30/0207; G06Q 30/0242; G06Q 30/0251; G06Q 50/12

(52) U.S. Cl. CPC G01C 21/3697; G01C 21/3476; G01C 21/362; G01C 21/367; G01C 21/3682; G06Q 30/0207; G06Q 30/0244; G06Q 30/0257; G06Q 30/0261; G06Q 50/12

(57) ABSTRACT

A Restaurant Promotion and Advertising System (RPAS) can provide customers with real-time information about promotions at nearby restaurants. The RPAS can allow restaurant owners to inform potential customers about the promotions being offered by that restaurant, in real time as the promotions are available. The RPAS can provide information about recurring promotions offered by a restaurant every week, and the RPAS can allow the recurring promotions to be submitted as repeating promotions, without the need for the promotion to be entered separately for each week.

### FIELD OF THE INVENTION

This disclosure relates to the field of restaurants, and more particularly, to restaurant promotions.

### BACKGROUND OF THE INVENTION

Restaurants are a highly competitive business. This can be good for the consumer, who can benefit from restaurants that try to use various promotions to compete against other restaurants and increase their business. However, in this competitive business, large chain restaurants have an unfair advantage due to their large advertising budgets. A typical large chain restaurant that pools profits across hundreds or thousands of stores can hire top advertising firms to produce professional advertisements and run them in local territories, effectively taking business from smaller restaurants in the same territories that arguably have better food in many cases.

Traditional platforms like social media sites and search engines typically operate on a top-down/“pay-to-play” model where visibility and success are largely determined by how much a business can afford to spend on advertising. This creates a barrier to entry for smaller, independent restaurants that cannot compete with the budgets of larger chains. Many restaurant apps focus primarily on takeout and delivery services, often neglecting the in-person dining experience that is central to social interaction and community building. Additionally these delivery apps can take upwards of 30% of the profits of an order when the industry as a whole only has a 5-10% profit margin to begin with.

Search engine ads can be a tool frequently used for restaurant marketing, but they come with high costs. The average cost per click (CPC) for restaurants can be expensive, and the cost per lead (CPL) can reach 15 or 20 times the cost per click. These expenses can be prohibitive for smaller restaurants, making it difficult for them to compete with larger establishments that have more substantial marketing budgets.

Social media sites are commonly used by restaurants for marketing, but these platforms often prioritize paid advertisements and constant updates. This means that even if a restaurant has a loyal following, their visibility may be limited unless they invest heavily in advertising. Even followers may not have visibility to a restaurant's promotion “post” because they may not actually be on social media at the time of advertising. Additionally, maintaining an active social media presence requires ongoing content creation and management, which can be both time-consuming and costly for small businesses. There is no way for a restaurant to post a recurring promotion, so every time a restaurant owner wants to post a Monday promotion, such as, for example, a “Monday service industry night” promotion, the restaurant has to create a new post for that day. Traditionally, standard advertising and promotional content is often tied to a Gregorian calendar based on numerical dates and months, which is inefficient when dealing with a recurring Monday through Sunday schedule. Furthermore ads on giant social media sites and search engines are built to campaign advertising systems which consist of a multi-day ad to get the most traction of visibility and does not focus on the “what is happening right now”.

Many of these small, local restaurants will try to compete by offering various promotions. These can take the form of weekly discounts, such as “taco Tuesday,” “burger Monday,” or can take the form of half-priced appetizers, or happy hours, during certain hours of the day on certain days of the week. Many promotions can be a discount on selected menu items during a particular time window. That time window can be defined as hours of the day and/or days of the week. Some promotions can be specials such as a special food item that is not on the menu every day of the week. These specials can be offered during a predetermined time window, or offered just one time until sold out, or offered seasonally when certain ingredients are more reasonably available. Some promotions can be events such as entertainment events, social events, music events, etc. This can include repeating events such as “karaoke Thursdays” or “Movie Mondays,” or can include one-time events such as a sporting event watching party, or a touring band having a live show at a particular bar or restaurant, etc.

However, with limited to no advertising budget, most small restaurants are unable to inform the relevant public about these promotions and specials. Some promotions may be mentioned on a card on the restaurant's table, or a calendar on a restaurant's wall. But these promotion techniques are only seen by customers who are already inside of the restaurant in the first place. This leads to the problem of restaurant owners offering discounts that cut into profits while not significantly increasing the number of new or different customers.

Similarly, potential new customers have no way to know about the promotions at a particular restaurant without physically going to that restaurant and inquiring about promotions, or even worse, calling to ask about promotions. These repeated phone calls to restaurant staff asking about promotions waste valuable time for the restaurant staff, resulting in lower-quality service for the customers who are already in the restaurant. On the other hand, any attempt to physically visit every restaurant in a potential customer's geographic area to check for discounts, promotions, and/or events during a particular time window is likely to require more time than the length of that time window. That is to say, if a user were to visit every small local restaurant in his geographic area on a Tuesday evening to see who had the best Tuesday promotion, Tuesday evening would be over and the promotions ended by the time the potential customer had visited every restaurant in the area and inquired about that day's promotions. This results in a potential customer who is tired and still hungry at the end of the day, and a restaurant owner has lost profit by offering a promotion that did not bring in any new customers. In some high-density areas, it can be impossible for a potential customer to learn about every restaurant's promotions for that day.

This problem is further compounded by potential customers who are travelling. People who travel often are some of the highest consumers of restaurant food. And, those people who eat in restaurants the most are often the least interested in eating in the same large chain restaurants, preferring to find good local food wherever they travel. But a traveler who is in a particular geographic area for a limited period of time simply cannot learn all of the relevant promotions for a given day of the week in every location they travel to. They default to various search engines, social media sites, or other restaurant websites for discovering where to go and are frequently misinformed on what is happening now or where to actually go that matches their preference of food offerings or activities. The restaurant industry is dynamic, yet there is currently no accessible platform for the public to discover local happenings in the moment.

Traditional methods for discovering local restaurant specials and events are often fragmented across multiple platforms, making it difficult for users to find real-time, accurate information. Additionally, there is no comprehensive way for the dining community to contribute and verify the accuracy of specials. There is a need for a unified, real-time system that not only allows independent restaurants to actively engage with diners but also enables users to verify and contribute to the information available.

What is needed is a way for small restaurants to compete by having information about their promotions readily available to potential consumers so that the promotions have the desired effect of bringing in customers, and particularly new customers. It would be desirable to have a system that allows a potential customer to realize he or she is hungry, quickly evaluate all of the available promotions in a given geographic area, find that customer's preferred promotion, and get to that restaurant, all in time to take advantage of that promotion and eat while the potential customer is hungry.

### SUMMARY OF THE INVENTION

This disclosure overcomes disadvantages of the prior art by providing a system and method allowing a restaurant owner to inform potential customers about various promotions at a restaurant, thereby allowing the restaurant owner to bring in new customers through the use of the promotion. This disclosure further overcomes disadvantages of the prior art by allowing a potential customer to quickly and easily examine all of the restaurant promotions within a geographic area so that the potential customer can find and enjoy a chosen restaurant promotion during the time that the promotion is still being offered.

The present disclosure provides a system for displaying real-time local restaurant deals and events through an interactive map and carousel interface, and can include filtering by radius of interest, type of special (food, drink, event), and day. The platform allows independent restaurants to engage with diners in real time. The interactive map and carousel can showcase promotions at local restaurants, allowing potential customers to find the best options near them without the clutter and complexity of traditional restaurant discovery platforms. The platform also enables customers to verify existing promotions and/or add new restaurant promotions to maintain an up-to-date system. Additionally if a restaurant is not found on the application, customers can submit a new restaurant to the platform. Customers can collaborate to confirm the accuracy of information through community verification, enhancing the reliability of the platform. The system can emphasize what is happening now, can allow customers to find current specials and events, and can empower the local community to keep the data relevant and accurate.

The RPAS can facilitate real-time engagement between local restaurants and customers. Unlike traditional platforms such as social media sites and search engines, which require significant time and financial investment to build a relevant online presence, the RPAS allows restaurant owners to immediately connect with nearby customers who are actively seeking specials and events. This real-time interaction is important and valuable in an industry where timing and relevance are critical.

According to an aspect of the invention, a method for displaying real-time restaurant promotional information can include determining a geographic location of a mobile communication device operated by a user, displaying a map representation of an area around the mobile communication device on a graphical user interface of the mobile communication device, superimposing on the map a plurality of location markers, each location marker corresponding to a restaurant within the area, displaying a carousel interface on the graphical user interface, the carousel interface containing a plurality of tiles, each tile corresponding to one of the restaurants represented by the location markers on the map, receiving a filter criterion from the user, the filter criterion specifying at least one of a time window and a promotion type, filtering the plurality of restaurants based on the filter criterion to identify restaurants having promotions matching the filter criterion, updating a visual appearance of the location markers on the map to indicate which restaurants have promotions matching the filter criterion, receiving a selection input from the user identifying a selected restaurant, highlighting the location marker for the selected restaurant with a prime tag on the map, simultaneously displaying a tile for the selected restaurant in a prime position of the carousel interface, and displaying promotional information for the selected restaurant on the tile in the prime position, the promotional information including a promotion title, a time window during which a promotion is available, and a description of the promotion. This synchronized map and carousel interface enables customers to rapidly evaluate multiple restaurant promotions while maintaining geographic context, allowing them to discover and reach restaurants offering desired promotions within the limited time windows during which those promotions remain available.

According to an embodiment, the filter criterion specifying a time window includes a day of the week selection and a time of day range. This enables customers to search for promotions available during specific recurring time periods, supporting discovery of weekly specials and time-limited offerings that match the customer's dining schedule.

According to an embodiment, the filter criterion specifying a promotion type includes at least one of a food promotion, a drink promotion, and an event promotion. This categorization enables customers to narrow their search to specific types of promotional offerings that match their interests, reducing cognitive load and supporting efficient discovery of relevant promotions.

According to an embodiment, updating the visual appearance of the location markers includes displaying location markers in different colors based on whether corresponding restaurants have promotions matching the filter criterion. This color-coded visual system enables customers to identify at a glance which restaurants offer promotions matching their search criteria, supporting rapid evaluation of geographic distribution of relevant promotional offerings.

According to an embodiment, the selection input comprises one of clicking on a location marker on the map and scrolling the carousel interface to position a tile in the prime position. This dual-input capability enables customers to explore restaurants through either geographic map-based navigation or list-based carousel scrolling, providing flexibility in how customers discover and evaluate promotional offerings.

According to an embodiment, the method further includes displaying a customer location indicator on the map showing the geographic location of the mobile communication device, and determining a distance between the customer location and each restaurant for display on the corresponding tile. This proximity information enables customers to make informed decisions about which promotions they can realistically reach within the available time window, supporting successful utilization of time-sensitive promotional offerings.

According to an embodiment, the prime tag comprises a visual border surrounding the location marker for the selected restaurant, the visual border having a different appearance than location markers for non-selected restaurants. This visual differentiation enables customers to immediately identify which restaurant is currently selected and being displayed in the carousel, maintaining clear correspondence between map and carousel interfaces during navigation.

According to an embodiment, the method further includes receiving a second selection input from the user identifying a second selected restaurant different from the selected restaurant, removing the prime tag from the location marker for the selected restaurant, highlighting the location marker for the second selected restaurant with the prime tag on the map, removing the tile for the selected restaurant from the prime position of the carousel interface, and simultaneously displaying a tile for the second selected restaurant in the prime position of the carousel interface. This dynamic updating capability enables customers to rapidly compare multiple restaurants and their respective promotions while maintaining synchronized map and carousel displays, supporting efficient evaluation of all available promotional options within the geographic area.

According to an aspect of the invention, a method for recording restaurant promotional information through community contribution may include receiving a customer indication to record a new promotion for a restaurant, displaying a promotion input interface on a graphical user interface of a mobile communication device, presenting a promotion type input field displaying closed-choice options for categorizing the promotion, receiving a customer selection of at least one promotion type from the closed-choice options, presenting a day selection input field displaying closed-choice options for days of the week, receiving a customer selection of at least one day of the week through the day selection input field, presenting a time window input field for specifying start and end times when the promotion is available, receiving customer-entered start and end times through the time window input field, presenting a description input field for entering information about the promotion, receiving a customer-entered description through the description input field, receiving a customer submission of the entered promotion information, processing the submitted promotion information by assigning initial authentication points based on a trust score of a recording customer, making the promotion information immediately available for display to other customers with an unverified status indicator, and initiating a community verification process for the submitted promotion. This community-driven recording system enables real-time dissemination of newly discovered promotional information without requiring dedicated data entry personnel, while the structured input format ensures compatibility with the system's filtering capabilities and the verification process maintains data accuracy through distributed community validation.

According to an embodiment, the method further includes displaying a promotion review screen showing the entered promotion information, and receiving a customer confirmation of the promotion information before making the promotion information available for display to other customers. This review step reduces the likelihood of errors in submitted promotional information by enabling recording customers to verify accuracy before publication, supporting overall data quality while maintaining rapid information dissemination.

According to an embodiment, the closed-choice options for promotion type include food, drink, and event categories. This standardized categorization ensures that all customer-submitted promotions can be accurately filtered by customers searching for specific types of promotional offerings, enabling precise matching of customer preferences with relevant promotions.

According to an embodiment, the description input field has a character limit that ensures the entered description fits within a promotion description display area on restaurant tiles. This character limitation maintains consistent formatting across all promotional displays regardless of information source, supporting the clean, streamlined interface that enables rapid evaluation of multiple promotional options.

According to an embodiment, initiating the community verification process includes displaying the promotion information to verifying customers with the unverified status indicator, receiving verification responses from verifying customers, assigning additional authentication points based on trust scores of the verifying customers, and removing the unverified status indicator when accumulated authentication points reach a predetermined threshold. This weighted verification system prioritizes feedback from reliable users while distributing the verification task across the community, achieving accurate validation without requiring dedicated verification personnel.

According to an embodiment, the method further includes receiving a verification response indicating that promotion details are incorrect, presenting a promotion correction interface to a correcting customer, receiving corrected promotion information through the promotion correction interface, and updating the promotion information based on the corrected promotion information. This correction capability enables efficient data maintenance by allowing any customer with accurate knowledge to fix errors directly, rather than requiring removal and re-entry of promotional information.

According to an embodiment, the method further includes increasing the trust score of the recording customer when the submitted promotion is verified by other customers, and awarding reward points to the recording customer for submitting the promotion information. This dual-reward system incentivizes both immediate contribution through reward points and sustained accurate participation through trust score increases, encouraging ongoing community engagement in maintaining comprehensive and accurate promotional data.

According to an aspect of the invention, a method for registering restaurant promotional information by a restaurant owner includes receiving restaurant owner authentication credentials through a login interface, verifying authority of a restaurant owner to manage promotional content for a restaurant, displaying a restaurant owner dashboard interface on a graphical user interface, presenting a day-by-day promotion management interface displaying each day of the week with indicators showing a number of promotions currently registered for each day, receiving a restaurant owner selection of a day of the week for which to register a new promotion, displaying a promotion registration interface in response to the restaurant owner selection, presenting a promotion type input field displaying closed-choice options for categorizing the promotion, receiving a restaurant owner selection of at least one promotion type from the closed-choice options, presenting a day selection input field displaying closed-choice options for days of the week, receiving a restaurant owner selection of at least one day of the week through the day selection input field, presenting a time window input field for specifying start and end times when the promotion is available, receiving restaurant owner-entered start and end times through the time window input field, presenting a description input field for entering information about the promotion, receiving a restaurant owner-entered description through the description input field, receiving a restaurant owner submission of the entered promotion information, processing the submitted promotion information without requiring community verification, and making the promotion information immediately available for display to customers without an unverified status indicator. This restaurant owner registration pathway enables immediate promotional visibility without verification delays, allowing restaurant owners to respond to real-time business conditions with promotional offerings that become instantly available to customers in the geographic area, while the structured input format ensures compatibility with customer-facing filtering capabilities.

According to an embodiment, the promotion is designated as a recurring weekly promotion that automatically appears on the selected at least one day of the week every week without requiring repeated data entry. This recurring promotion capability eliminates the need for restaurant owners to repeatedly enter the same promotional information each week, significantly reducing the time and effort required to maintain consistent promotional presence while ensuring customers can rely on predictable weekly promotional schedules.

According to an embodiment, the method further includes automatically displaying the registered promotion to customers when a current time falls within the specified start and end times and a customer filter criterion matches the selected at least one promotion type and the selected at least one day of the week. This automatic temporal filtering ensures that customers see only currently available promotions that match their search criteria, supporting discovery of actionable promotional opportunities without requiring customers to manually evaluate timing information.

According to an embodiment, the method further includes receiving a restaurant owner designation of the promotion as an ad hoc promotion, and limiting display of the ad hoc promotion to a single occurrence rather than recurring weekly. This ad hoc promotion capability enables restaurant owners to create one-time promotional offerings in response to immediate business conditions, providing flexibility to supplement recurring promotions with spontaneous specials that address real-time circumstances.

According to an embodiment, the method further includes transmitting a push notification to customers within a geographic radius of the restaurant when the promotion is registered, and targeting the push notification to customers whose preference criteria match the selected at least one promotion type. This targeted notification system enables restaurant owners to reach interested customers immediately upon registering new promotions, driving rapid customer response while respecting customer preferences by limiting notifications to relevant promotional offerings.

According to an aspect of the invention, a method for displaying restaurant density information includes determining geographic locations of a plurality of mobile communication devices operated by users within an area, displaying a map representation of the area on a graphical user interface of a mobile communication device, superimposing on the map a plurality of location markers, each location marker corresponding to a restaurant within the area, determining a number of users currently located within a predetermined radius of each restaurant based on the geographic locations of the plurality of mobile communication devices, calculating a density value for each restaurant based on the determined number of users, displaying a density indicator for each restaurant on the map, the density indicator having a visual appearance that varies based on the calculated density value, and updating the density indicators in real-time as the geographic locations of the plurality of mobile communication devices change. This real-time density visualization enables customers to make informed decisions about restaurant selection based on current crowding levels, supporting optimization of dining experiences by allowing customers to choose between popular venues with high social atmosphere and quieter establishments with lower density.

According to an embodiment, the density indicator comprises a border surrounding the location marker, the border having a width that increases with increasing density value. This variable-width border system provides intuitive visual communication of relative restaurant density levels, enabling customers to quickly assess crowding across multiple establishments through simple visual comparison of border widths.

According to an embodiment, the method further includes determining whether each user has remained within the predetermined radius of a restaurant for a predetermined time period, and counting only users who have remained within the predetermined radius for the predetermined time period toward the number of users currently located at the restaurant. This time-based threshold prevents transient users from being counted as restaurant customers, ensuring that density indicators reflect actual dining activity rather than foot traffic, thereby providing more accurate information about restaurant crowding levels.

According to an embodiment, calculating the density value comprises dividing the number of users currently located within the predetermined radius by at least one of a number of tables at the restaurant and a square footage of the restaurant. This normalization of customer counts by restaurant capacity provides more meaningful density information by accounting for establishment size, enabling fair comparison between restaurants of different sizes and supporting customer decisions about relative crowding levels.

According to an embodiment, the method further includes displaying promotional information for restaurants on a carousel interface synchronized with the map, and simultaneously displaying both the density indicator and promotional information for a selected restaurant. This integration of density information with promotional discovery enables customers to evaluate both the attractiveness of promotional offerings and the current crowding levels at restaurants, supporting comprehensive decision-making that considers both promotional value and desired dining atmosphere.

According to an aspect of the invention, a restaurant promotion and advertising system includes a processor, and a non-transitory computer-readable medium storing instructions that, when executed by the processor, cause the system to determine a geographic location of a mobile communication device operated by a user, display a map representation of an area around the mobile communication device on a graphical user interface of the mobile communication device, superimpose on the map a plurality of location markers, each location marker corresponding to a restaurant within the area, display a carousel interface on the graphical user interface, the carousel interface containing a plurality of tiles, each tile corresponding to one of the restaurants represented by the location markers on the map, receive a filter criterion from the user specifying at least one of a time window and a promotion type, filter the plurality of restaurants based on the filter criterion to identify restaurants having promotions matching the filter criterion, update a visual appearance of the location markers on the map to indicate which restaurants have promotions matching the filter criterion, receive a selection input from the user identifying a selected restaurant, highlight the location marker for the selected restaurant with a prime tag on the map, simultaneously display a tile for the selected restaurant in a prime position of the carousel interface, and display promotional information for the selected restaurant on the tile in the prime position. This system architecture enables real-time restaurant promotion discovery through synchronized map and carousel interfaces that provide both geographic context and detailed promotional information, supporting rapid evaluation and selection of dining options based on location, timing, and promotional offerings.

According to an embodiment, the instructions may further cause the system to receive a customer indication to record a new promotion for a restaurant, display a promotion input interface with structured input fields, receive promotion information through the structured input fields, assign initial authentication points based on a trust score of a recording customer, and make the promotion information available for display with an unverified status indicator. This community contribution capability enables real-time dissemination of newly discovered promotional information while maintaining transparency about verification status, supporting comprehensive promotional coverage without requiring dedicated data entry personnel.

According to an embodiment, the instructions may further cause the system to display the promotion information to verifying customers, receive verification responses from verifying customers, assign additional authentication points based on trust scores of the verifying customers, and remove the unverified status indicator when accumulated authentication points reach a predetermined threshold. This distributed verification system achieves data accuracy through community participation while maintaining real-time information availability, enabling rapid promotion discovery without sacrificing reliability.

According to an embodiment, the instructions may further cause the system to receive restaurant owner authentication credentials, verify authority of a restaurant owner to manage promotional content for a restaurant, receive promotion information from the restaurant owner, and make the promotion information immediately available for display without requiring community verification. This dual-pathway system enables both community-driven promotion discovery and restaurant owner-controlled promotion management, providing immediate visibility for owner-registered promotions while maintaining community verification for customer-submitted information.

According to an embodiment, the instructions may further cause the system to determine a number of users currently located within a predetermined radius of each restaurant, calculate a density value for each restaurant based on the determined number of users, and display a density indicator for each restaurant on the map, the density indicator having a visual appearance that varies based on the calculated density value. This integrated density visualization enables customers to evaluate both promotional offerings and current crowding levels simultaneously, supporting comprehensive dining decisions that consider both promotional value and desired dining atmosphere.

According to an aspect of the invention, a restaurant promotion and advertising system may include a processor, a database coupled to the processor, the database storing restaurant information including restaurant names, addresses, and geographic coordinates, and promotion information including promotion types, time windows, and promotion descriptions, a network interface coupled to the processor and configured to communicate with a plurality of mobile communication devices over a wireless network, a restaurant information module executed by the processor and configured to maintain restaurant information in the database, a restaurant promotion information module executed by the processor and configured to maintain promotion information in the database, a user output module executed by the processor and configured to transmit restaurant information and promotion information to the plurality of mobile communication devices in response to requests from the mobile communication devices, a user input module executed by the processor and configured to receive promotion information from the plurality of mobile communication devices, a promotion information input module executed by the processor and configured to process promotion information received from restaurant owners and from customers, a promotion verification module executed by the processor and configured to manage community-based verification of customer-submitted promotion information by assigning authentication points based on trust scores of recording customers and verifying customers, and a map generation component executed by the processor and configured to generate map representations displaying location markers for restaurants and carousel interfaces displaying tiles for restaurants, wherein the map generation component synchronizes highlighting of location markers with display of corresponding tiles in a prime position of the carousel interface. This modular system architecture enables efficient processing of different types of information while maintaining system coherence, supporting real-time restaurant promotion discovery through coordinated operation of specialized functional modules.

According to an embodiment, the system may further include a customer information module executed by the processor and configured to maintain customer data including trust scores and reward point balances, wherein the promotion verification module assigns authentication points to customer-submitted promotions based on trust scores retrieved from the customer information module. This integration of trust scores into the verification process creates a weighted validation system that prioritizes feedback from reliable users, improving verification accuracy while incentivizing sustained accurate participation through reputation-based rewards.

According to an embodiment, the system may further include a restaurant owner module executed by the processor and configured to maintain restaurant owner subscription information and login credentials, wherein the promotion information input module processes restaurant owner-submitted promotions without requiring community verification when the restaurant owner is authenticated through the restaurant owner module. This authentication-based processing pathway enables immediate promotional visibility for verified restaurant owners while maintaining community verification requirements for customer submissions, balancing real-time responsiveness with data accuracy.

According to an embodiment, the system may further include a restaurant information verification module executed by the processor and configured to manage community-based verification of customer-submitted restaurant information by assigning authentication points based on trust scores of recording customers and verifying customers. This parallel verification system for restaurant information ensures that both promotional content and foundational restaurant data maintain accuracy through community participation, supporting comprehensive data quality across all system information.

According to an embodiment, the user output module may be configured to update the restaurant information and promotion information transmitted to the mobile communication devices in response to revised filter criteria received from the mobile communication devices, the revised filter criteria including at least one of a revised geographic area, a revised time window, and a revised promotion type. This dynamic filtering capability enables customers to refine their search parameters and immediately see updated results, supporting iterative exploration of promotional offerings until customers identify options that match their specific preferences and constraints.

According to an embodiment, the map generation component may be configured to display location markers with different visual appearances based on whether corresponding restaurants have promotions matching filter criteria specified by a user, and update the visual appearances of the location markers in real-time as the filter criteria change. This responsive visual feedback system enables customers to immediately understand the impact of filter adjustments on available promotional options, supporting efficient refinement of search parameters to identify desired promotions.

According to an embodiment, the system may further include a third-party restaurant information input module executed by the processor and configured to receive restaurant information from third-party business listings and map services, wherein the restaurant information module integrates the restaurant information received from the third-party restaurant information input module with customer-submitted restaurant information and restaurant owner-submitted restaurant information. This integration of multiple information sources reduces manual data entry requirements while expanding the system's restaurant database, supporting comprehensive coverage of local dining establishments through combination of established business directories and community contributions.

According to an aspect of the invention, a restaurant promotion and advertising system may include a processor, and a non-transitory computer-readable medium storing instructions that, when executed by the processor, cause the system to determine geographic locations of a plurality of mobile communication devices operated by users within an area, display a map representation of the area on a graphical user interface of a mobile communication device, superimpose on the map a plurality of location markers, each location marker corresponding to a restaurant within the area, determine a number of users currently located within a predetermined radius of each restaurant based on the geographic locations of the plurality of mobile communication devices, calculate a density value for each restaurant based on the determined number of users, display a density indicator for each restaurant on the map, the density indicator having a visual appearance that varies based on the calculated density value, and update the density indicators in real-time as the geographic locations of the plurality of mobile communication devices change. This real-time density monitoring system provides customers with current information about restaurant activity levels, enabling informed decisions about dining venue selection based on desired crowding levels and social atmosphere preferences.

According to an embodiment, the density indicator may comprise a border surrounding the location marker, the border having a width that increases with increasing density value. This variable-width visual encoding provides intuitive communication of relative density levels across multiple restaurants, enabling rapid assessment of crowding through simple visual comparison without requiring numerical interpretation.

According to an embodiment, the instructions may further cause the system to determine whether each user has remained within the predetermined radius of a restaurant for a predetermined time period, and count only users who have remained within the predetermined radius for the predetermined time period toward the number of users currently located at the restaurant. This temporal filtering of user counts ensures that density measurements reflect actual dining activity rather than transient foot traffic, providing more accurate and meaningful information about restaurant crowding levels for customers making dining decisions

### BRIEF DESCRIPTION OF THE DRAWINGS

The invention description below refers to the accompanying drawings, of which:

FIG. 1A is a representative view of phone app user interface for a Restaurant Promotion and Advertising System (RPAS), according to an illustrative embodiment;

FIG. 1B is a representative view of a first face for a restaurant tile displaying restaurant information about promotions at a particular restaurant, according to an illustrative embodiment;

FIG. 1C is a representative view of a second face for a restaurant tile displaying restaurant information about the location of a particular restaurant, according to an illustrative embodiment;

FIG. 2A is a representative view of a RPAS at start up, according to an illustrative embodiment;

FIG. 2B shows the RPAS of FIG. 2A after the customer has clicked on the tag 214 for restaurant B, according to an illustrative embodiment;

FIG. 2C shows the RPAS of FIG. 2B after a customer has clicked on the tag 216 for restaurant C, according to an illustrative embodiment;

FIG. 2D shows the RPAS of FIG. 2C after a customer has scrolled the carousel to the next position, according to an illustrative embodiment;

FIG. 2E shows the RPAS of FIG. 2D after a customer has adjusted the time window filter, according to an illustrative embodiment;

FIG. 2F shows the RPAS of FIG. 2E after a customer has adjusted the promotion type filter to display only events, and has returned the time window filter to the current time, according to an illustrative embodiment;

FIG. 2G shows the RPAS of FIG. 2F after a customer has reduced the radius of the geographic area around the customer, according to an illustrative embodiment;

FIG. 2H shows the RPAS of FIG. 2G after a customer has increased the radius of the geographic area around the customer 202 and has added a promotion to restaurant C, according to an illustrative embodiment;

FIG. 3A is a representative view of a promotion recording interface for a recording customer, according to an illustrative embodiment;

FIG. 3B is a representative view of a promotion reviewing interface for a recording customer, according to an illustrative embodiment;

FIG. 4A is a representative view of a RPAS showing an unverified promotion, according to an illustrative embodiment;

FIG. 4B is a representative view of a promotion verifying interface for a verifying customer, according to an illustrative embodiment;

FIG. 5A is a representative view of a promotion correction system for a correcting customer, according to an illustrative embodiment;

FIG. 5B is a representative view of a correction reviewing interface for a correcting customer, according to an illustrative embodiment;

FIG. 6 is a representative view of a customer dashboard, according to an illustrative embodiment;

FIG. 7 is a representative view of a restaurant owner dashboard and promotion input interface, according to an illustrative embodiment;

FIG. 8 is a representative view of a restaurant owner promotion registration system, according to an illustrative embodiment;

FIG. 9A is a representative view of a heat map overlay for a RPAS, according to an illustrative embodiment;

FIG. 9B is a representative view of a heat map overlay for a RPAS at a different time of day, according to an illustrative embodiment;

FIG. 10 is a schematic computing system environment for a RPAS, according to an illustrative embodiment; and

FIG. 11 is a schematic processing environment for a RPAS, according to an illustrative embodiment.

### DETAILED DESCRIPTION

The invention described herein includes a novel system and method for promoting restaurants, including an up-to-date listing of local restaurants and restaurant promotions. Although this system and method has been disclosed in the context of certain preferred embodiments and examples, it should be understood that the present system and method extends beyond the specifically disclosed embodiments and/or uses described herein. Thus, it is intended that the scope of the present disclosure should not be limited by the particular disclosed embodiments described herein.

In various instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, any particular embodiment need not have all the aspects or advantages described herein. Thus, in various embodiments, any of the features described herein from different embodiments may be combined. It should be clear that the examples below are descriptions of implementations of the invention, and not descriptions of the invention, which is not limited to the detailed implementations described in this section but is described in broader terms in the claims. Further, the terms and phrases used herein are not intended to be limiting but rather to provide an understandable description of the invention.

Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation.

A Restaurant Promotion and Advertising System (RPAS) provides information to potential customers about restaurants and restaurant promotions in their geographic area. Customers can find recurring events, specials, and other promotions hosted by local restaurants near them. A potential customer can quickly examine all of the promotions available at various restaurants within the chosen geographical area. In various embodiments, an RPAS can include various user interfaces, including but not limited to, a phone app, a computer app, and/or a website. The RPAS described herein can connect consumers with local dining establishments through an interactive map. The RPAS can provide consumers with information about restaurants, including locations, various promotions, time windows for various promotions, information regarding restaurant popularity or current customer activity, and/or other information about restaurants.

As used herein, the term restaurants can be used to refer to various restaurants, bars, concert venues, food trucks, and/or other establishments that may serve food, serve drinks, have events, and/or run various promotions covering or centering around various food, drinks, and/or events. As used herein, the term “restaurant” is not intended to be limiting and can include various establishments that may or may not serve food.

As used herein, the term “potential customer” can include any person who may be interested in finding and going to a restaurant in that potential customer's area. A potential customer can use an RPAS to learn about restaurants in a geographic area so that the potential customer can select a restaurant and go to that restaurant. The potential customer can use information about restaurant promotions to guide a decision about which restaurants the potential customer will visit. As used herein, the term “current customer” refers to any patron who is currently at a restaurant. This can include anyone visiting a food truck or other establishment regardless of whether or not the current customer is actually inside of a building. As used herein, the term “new customer” refers to a patron who is currently visiting a particular restaurant for the first time. As used herein, the term “potential new customer” refers to a potential customer who is using an RPAS to learn about a restaurant that customer has not been to before. As used herein, the term “customer” can refer to potential customers, current customers, new customers, and/or potential new customers.

As used herein, the term “restaurant owner” can refer to any person or persons who owns a restaurant, manages a restaurant, does marketing for a restaurant, or anyone who has a duty or interest in increasing customer traffic to a particular restaurant.

As used herein, the term “promotion” can include any number of various ways a restaurant owner may attempt to entice potential customers into becoming current customers. Promotions can include promotions on food such as food discounts. As used herein, the term “food discount” can refer to a reduced price on food items. In many cases, a food discount can apply to certain food items that can be less than all of the food items available at a restaurant. In various embodiments, a food discount can be a weekly food discount that can be repeated on the same day every week. By way of non-limiting example, a weekly food discount can include “taco Tuesdays” that can be reduced-price tacos on Tuesdays, or free guacamole with tacos purchased on Tuesdays, or other options. Other popular food discounts can include reduced-price burgers for a “burger Monday” promotion, or half priced appetizers during certain hours on Monday through Thursday, or other various discounts on food.

Promotions on food can include food specials. Food specials can be a particular food item that is not on the menu every day of the week. These specials can be offered during a predetermined time window, or offered just one time until sold out, or offered seasonally when certain ingredients are more reasonably available. In various embodiments, specials may include weekly recurring specials, such as different burger toppings on different days of the week. By way of non-limiting example, weekly specials could include black-and-blue burgers that are only available on Wednesdays, or pastrami burgers that are only available on Thursdays.

Promotions can include drink discounts. Drink discounts can refer to reduced prices on drinks. In many cases, a drink discount can apply to certain drinks that can be less than all of the drinks available at a restaurant. In various embodiments, a drink discount can be a weekly drink discount that can be repeated on the same day every week. By way of non-limiting example, a drink discount can include $1 off of all tap beers on Mondays, or $5 rum and cola drinks on Thursdays.

Promotions can include events such as entertainment events, social events, music events, etc. This can include repeating events such as “Live Band Thursdays” or “Open Mic Mondays,” or can include one-time events such as a sporting event watching party, costume parties, or a touring band having a show at a particular restaurant, etc.

The term promotion can refer to various food discounts, drink discounts, food specials, events, etc., however, the term promotion can also be used to refer to any means by which a restaurant owner may entice potential customers into becoming current customers. By way of non-limiting example, a promotion could also include giveaways such as alcohol company branded swag gifts, free pool tables, music themes, seasonal drink specials, and/or any other lure used by restaurant owner to entice potential customers into becoming current customers.

Some promotions can be limited by a time window. As used herein, a time window can include specific days of the week and/or specific times during the day. Examples of time windows can include weekly specials such as reduced-price tacos, available only on Tuesdays between 5 PM and 9 PM, reduced-price happy hour drink promotions that are only offered on weekdays from 5 PM to 7 PM, or prime rib only available on Saturdays until it runs out. Time windows can include certain days of the week, certain days of the year, and/or certain times of a day. Time windows can provide a limit on the availability of various promotions.

The RPAS can have a public-facing recurring calendar, which can categorize specials and events by day of the week rather than specific dates. As used herein, the term “public-facing recurring calendar” can include a system that categorizes specials and events by day of the week, rather than specific dates, to provide a streamlined view of what's happening in the local dining scene, and makes that information easily accessible to the public. This lean and efficient system can use a day-based function to map events to the current day, allowing customers to see what's happening around them without the clutter of outdated information. Unlike advertising formats that require a restaurant owner to schedule their specials for each specific date into the future, restaurants can set their promotions on a particular day of the week and then forget them, or opt to update them as needed, reducing the time and effort required to maintain their presence on the RPAS. The RPAS can then display the repeating promotions on the same day of the week, every week until the promotion changes.

The platform can offer a unique geolocational pairing feature that allows restaurants to target customers within a specific radius who have expressed interest in certain types of promotions or events. As used herein, the term geolocational pairing refers to the process of matching customers with relevant promotions based on their geographic location and expressed preferences. This elective advertising system can give customers more control over the promotions they see, making the experience more personalized and relevant. For restaurant owners, this means they can engage with a highly interested audience in real-time, optimizing their marketing efforts without the need for frequent posts or updates.

The RPAS can provide benefits to at least two distinct user groups. The RPAS can benefit customers looking for real-time dining options, local events, and promotions without the hassle of navigating through endless reviews and advertisements. The RPAS can also benefit independent restaurant owners who seek to offer their promotions directly to local patrons in a cost-effective manner, without relying on pay-to-play advertising platforms.

Many restaurant apps focus primarily on takeout and delivery services, often neglecting the in-person dining experience that is central to social interaction and community building. The RPAS described herein differentiates itself by prioritizing the in-person dining experience and providing a platform for real-time engagement between customers and restaurants. This emphasis on fostering community connections sets the RPAS described herein apart from other platforms.

The RPAS described herein can be a digital platform designed to allow restaurants and customers to connect in real-time. This community-based RPAS enables customers to discover local food and beverage specials, as well as social events, and/or other promotions, through an interactive map interface that can dynamically update based on customer input and verification. Unlike traditional platforms where visibility is often tied to advertising spend and social media following, the RPAS can be a vendor-agnostic solution that levels the playing field for all dining establishments whether or not the restaurant is offering any promotions. As used herein, the term vendor-agnostic can refer to a platform that does not favor any particular vendor or restaurant, regardless of budget or expenditure, ensuring equal visibility for all participants.

The RPAS can be a community-driven platform that can aggregate and display information regarding various promotions for local restaurants. The RPAS can present this information through an interactive, consumer-driven interface that can include an interactive map-and-carousel system that is dynamically updated based on customer input and verification. The interactive map and carousel can showcase promotions at local restaurants, allowing potential customers to find the best options near them without the clutter and complexity of traditional restaurant discovery platforms.

The RPAS can provide a clean and efficient user experience, free from the noise of endless scrolling, reviews, and/or image content. The PRAS can present customers with a clear, concise view of the dining options available around them, enhancing their experience by focusing on real-time restaurant promotions. For restaurant owners, this streamlined approach means less time spent on managing their online presence and more time focusing on delivering great food and service

In the interest of clarity and ease of description, the RPAS described herein is described in the context of possible exemplary user interfaces and possible exemplary data entry systems. However, it should be clear that various user interfaces and data entry systems are possible. In various embodiments, the appearance or data entry methods as shown and described herein may not be required, and various appearances and/or data entry systems can be used.

The RPAS can use an interactive map interface which can allow customers to explore local dining options in real-time. The map can dynamically update as customers scroll through a carousel of restaurants, each associated with active specials and events. This seamless interaction between the map and the carousel ensures that customers can easily navigate their options and find exactly what the customer is looking for.

The interactive map can display restaurant promotions as location-based markers, which can also be referred to as tags. Each marker can be dynamically updated based on real-time information from the restaurant calendar or customer contributions. These markers can be paired with a carousel tile that lists the promotions, providing detailed descriptions. When a customer interacts with a map marker, the carousel can highlight the promotions at the corresponding restaurant. Similarly, when the customer interacts with the carousel, the map marker highlights the location of the restaurant offering the promotion shown on the carousel.

The carousel can allow customers to swipe through restaurants and promotions. As the consumer interacts with the carousel, the corresponding restaurant's location can be displayed on the interactive map, which can update in real-time to reflect the restaurant's geographic location. This unique combination of an interactive map synchronized with a carousel interface allows customers to visually explore restaurant locations while swiping through a list. The map can serve as a visual representation of the restaurants and promotions. As customers scroll through the carousel, the map can automatically adjust to display the relevant locations, enhancing user navigation and engagement. This seamless integration of map locations and the carousel can create a fluid user experience, allowing customers to switch between visual map-based exploration and list-based browsing. The RPAS can provide real-time, location-based offerings, ensuring that customers see what is happening around them today. These real-time specials and events can create a sense of urgency and excitement, encouraging customers to take advantage of current offers.

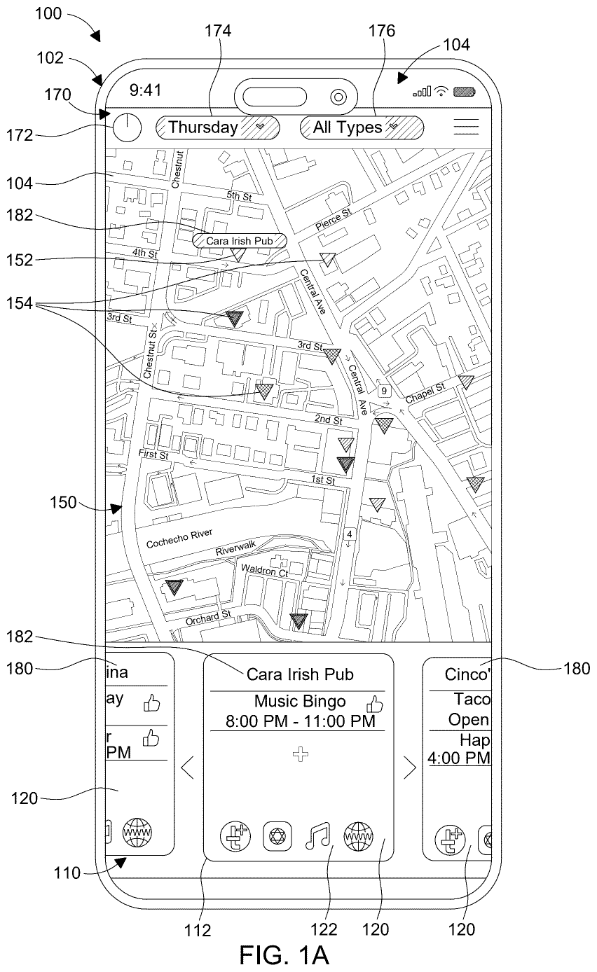

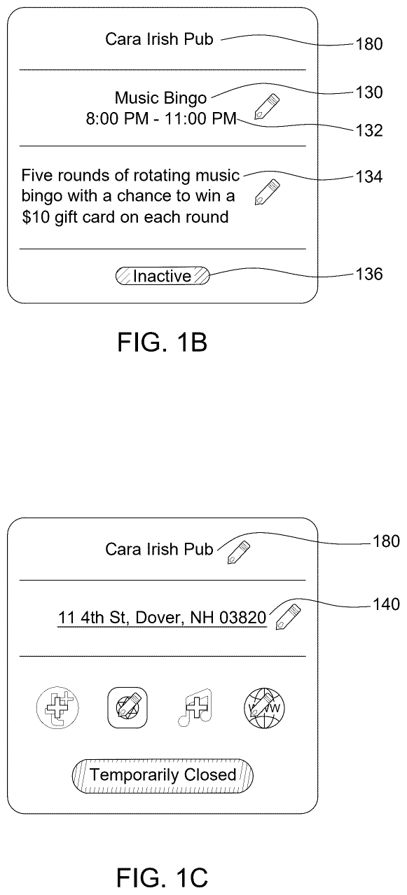

FIG. 1 is a representative view of phone app user interface for a Restaurant Promotion and Advertising System (RPAS), according to an illustrative embodiment. An RPAS 100 can have various interfaces, including a phone app that can be displayed on a screen 104 of a smart phone 102. In various embodiments, the RPAS can also be displayed on or used through a personal computer, tablet, automobile screen, smart phone, smart watch, smart glasses, or other technology currently in existence or invented in the future.

An RPAS can provide an integrated interface that combines both map-based and list-based restaurant discovery. An RPAS 100 can have a scrolling area such as carousel 110, and can have a map area with map 150. This dual-interface approach allows users to simultaneously view restaurant locations geographically while browsing through detailed promotional information.

Carousel 110 is shown oriented at the bottom of the screen 104 of a cell phone 102, with the map 150 positioned above the carousel, however, it should be clear that in various embodiments and in use on various sizes and locations of screens, the carousel and/or map can be in various locations on the screen or even can be located on separate screens that can be nearby to each other. However, for the sake of simplicity and ease of description, the RPAS described herein will be described with the carousel located in a lower portion of the screen and a map located in an upper portion of the screen. The map and carousel can simultaneously display restaurants within a chosen radius or a chosen map area.

The map 150 can display various restaurants 180 as location-based markers or tags 154 on the map 150. Each tag 154 can represent an individual restaurant. All of the restaurants in a chosen geographic area can be displayed as tags 154 on the map 150.

Restaurants 180 can also be displayed in the carousel 110. The carousel 110 can include a series of tiles 120, and each tile 120 can represent an individual restaurant 180. The carousel 110 can include a unique tile 120 for each individual restaurant 180 shown on the map 150. In various embodiments, less than all of the tiles can be displayed on the screen at any particular moment. The customer can scroll the carousel to move different tiles into place on the screen. Put another way, the RPAS can maintain all of the tiles for all of the restaurants 180 shown on the map 150 in a line, or loop, that can extend beyond the edges of the screen, and that loop of tiles can be rotated into position on the screen. That loop of tiles can be referred to as the carousel 110.

Each tile 120 can display restaurant information about a restaurant 180. As used herein, the term “restaurant information” can include the name of the restaurant, the location, available promotions, any time window for the promotions, restaurant hours, links to the restaurant's website, links to various social media, and/or other information. In various embodiments, a customer can tap on a tile to toggle different information to appear on that tile. In various embodiments, a tile may have two or more “faces,” and a customer can toggle between different faces by, for example, tapping on that tile.

The customer can scroll the carousel, placing each restaurant on the carousel in the prime location one by one. As each restaurant is placed in the prime position, that restaurant's specials can be shown on the screen and their location can be highlighted on the map at the same time.

FIG. 1B is a representative view of a first face for a restaurant tile displaying restaurant information about promotions at a particular restaurant, according to an illustrative embodiment. A tile face may include the name of the restaurant 180, a promotion title 130, a promotion time window 132, a promotion description 134, promotion status 136, and/or other information about the available promotion. In various embodiments, the first tile face can show the current promotion(s) that are currently available at that moment, in real time.

As used herein, the term “current promotion” can refer to any promotion that is available at the moment the potential customer is looking at the RPAS. That is to say, any promotion for which the time window of that promotion includes the current time, can be referred to as a current promotion. In various embodiments, the term current promotion may also include promotions that are scheduled to start within a predetermined number of minutes into the future, such as, for example, promotions that will start within the next 30 minutes or less.

FIG. 1C is a representative view of a second face for a restaurant tile displaying restaurant information about the location of a particular restaurant, according to an illustrative embodiment. A tile face may include the name of the restaurant 180 and static information 140 such as the restaurant's hours, the restaurant's location, links to navigation that will help a customer navigate to the restaurant, links to a restaurant's website, social media platforms, or other information.

As described herein, a first tile can include current promotions and a second tile can include static information about a restaurant such as location. However, it should be clear that in various embodiments, various possible combinations of restaurant information can be displayed on different tile faces, and various tile faces are possible. Various tile faces can include multiple tile faces for multiple promotions offered by that restaurant. In various embodiments, a first tile can show a current, real-time promotion available in the current time window, and one or more tiles may allow a potential customer to see additional promotions and/or future promotions at that restaurant that are outside of the current time window. In various embodiments, a restaurant with more than one current promotion may have each current promotion displayed on separate tiles, or may have all current promotions displayed on a first tile. In various embodiments, a restaurant with more than one current promotion may have all current promotions displayed in a list format on the first tile, and additional information such as descriptions of the promotion and/or time windows for the promotions may be displayed on subsequent tiles. In various embodiments, all information can be displayed on a single tile, without the need for toggling.

The carousel 110 can display a single tile in the prime position 112. As shown in FIG. 1, the prime position 112 is in a center portion of the screen, but it should be clear that the prime position 112 can be at the left, right, top, bottom, or any location along the carousel 110. The prime tile 122 in prime position 112 can display the prime restaurant 182. The prime restaurant 182 that is in the prime position 112 can be simultaneously identified on the map with a prime tag 152.

In various embodiments, the prime tag 152 can be a different appearance than other tags 154. In various embodiments, the prime tag can be a different color than other tags, can be a different size, can be a different shape, can blink, can appear to be shaded or hollow, and/or other various ways to make the prime tag quickly obvious to the customer. In various embodiments, the prime tag 152 may include the name of the prime restaurant 182.

The prime tag highlights the prime restaurant so that the customer can quickly and easily see where the prime restaurant is located on the map. In various embodiments, a customer can also see where that customer is located on the map, so that customer can see the location of the prime restaurant relative to that customer, explained more fully below.

In addition to the prime tag having a different appearance from other tags, other tags can have different appearances from each other. In various embodiments, different appearances of different tags can signify different bits of restaurant information. For example, a first tag color, such as red, can signify that all restaurants with that tag color have active current promotions. Various tag colors can be used to signify that restaurants with that tag color have promotions during a time window selected by the customer. Various tag colors can be used to signify that a restaurant has promotions, but no current promotions or no promotions during the selected time window. Various tag colors can be used to identify restaurants that are in the map area but have no known specials. Although the PRAS is described herein as displaying various restaurant information through different tag colors, it should be clear that restaurant information can be displayed through any number of different tag appearances. Various ways to present restaurant information through tag appearances can include, but are not limited to, tags with different shapes, different sizes, different color intensities, various patterns of flashing, spinning, and/or other various other ways to show different tag appearances. As used herein, descriptions of different colors, different color intensities, different shapes, different flashings, or other different appearances for restaurant tags can be used interchangeably, and are intended to indicate various ways that different information can be conveyed on the map.

A RPAS 100 can give a customer the option to apply and/or adjust one or more filters. The RPAS can have a filter panel 170 that can include one or more filters, such as a distance filter 172, a time window filter 174, and/or a filter for promotion types 176. A distance filter 172 can allow a customer to set a maximum distance the customer is willing to travel from the customer's current location. This distance filter can limit the restaurants that are displayed on the map and the carousel to a specific radius selected by the customer. The specific geographic area chosen by the customer can be referred to as the selected geographic area. In various embodiments, the customer may be able to adjust the selected geographic area by manipulating the map area. For example, the customer may be able to reduce the map area using a pinch gesture on the map, or scroll out to increase the map area. In various embodiments, adjusting the area of the map will adjust the selected geographic area. In various embodiments, a customer may be able to adjust the geographic area by selecting a radius and/or manipulating the map area. Adjusting the selected geographic area can change the restaurants being shown on the RPAS. Changing the restaurants being shown on the RPAS can simultaneously change the restaurants shown on the map and the restaurants in the carousel. Regardless of the selected geographic area or changes to the selected geographic area, the restaurants shown on the map can be shown on the carousel, and the restaurants on the carousel can be shown on the map.

A time window filter 174 can allow a customer to look at the promotions available in a particular snapshot of a time window. At default, the time window filter can be set to the current day and time, so that the RPAS shows all current promotions available at that current moment. A time window filter 174 can also allow a customer to set the RPAS to display promotions that will be available in a future time window, including future days of the week and/or future times of day. For example, a customer may want to check to see what promotions are available in a selected geographic area for lunchtime tomorrow. In various embodiments, potential customers can look into the future, such as, for example looking in advance to see which restaurants will have costume parties on Halloween, outdoor game events on Memorial Day, or sports watching events during important sporting events such as championship games.

A promotion type filter 176 can allow a customer to narrow the displayed promotions to only a particular type of promotion, such as events or drink specials. Various other filters may be possible. In various embodiments, all restaurants within the selected geographic area can be displayed on the map and on the carousel, regardless of the particular time window or particular promotions. The status or absence of different promotions at different restaurants can be identified by tags 154 that have different appearances. In various embodiments, a customer may be able to “turn off,” or remove restaurants from the map and/or carousel if those restaurants do not have promotions within the selected filter parameters.

In various embodiments, a customer may be able to filter promotions by keywords. By way of non-limiting example, this can include narrowing the displayed promotions to only promotions that include the word “taco” in the promotion title, or narrowing the displayed promotions to only promotions that include a particular brand of alcohol or type of drink in the promotion description. Various search functions may allow a customer to filter promotions so that only promotions that match the customer's criteria are shown.

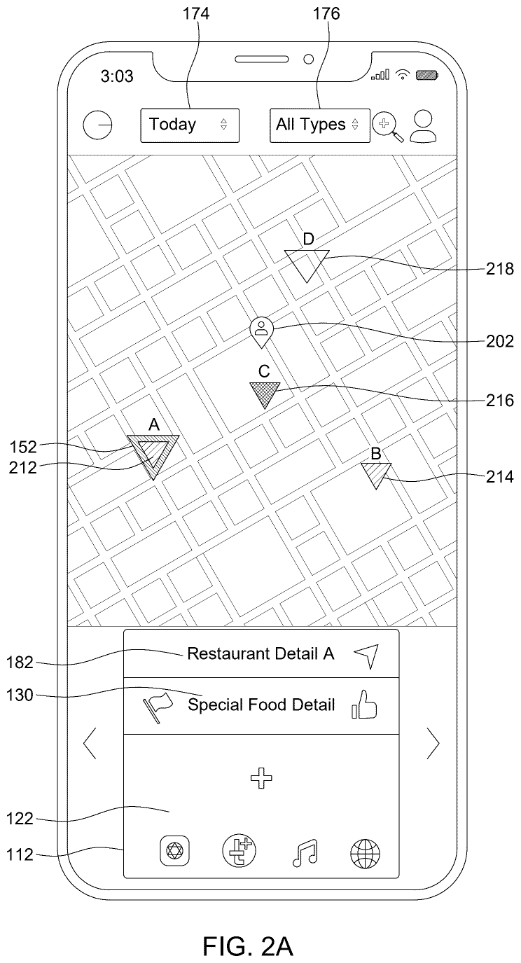

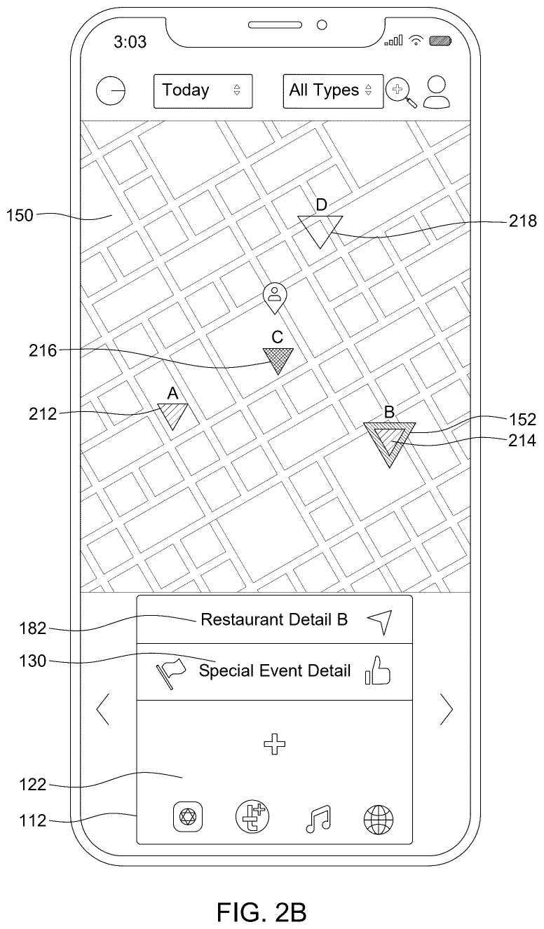

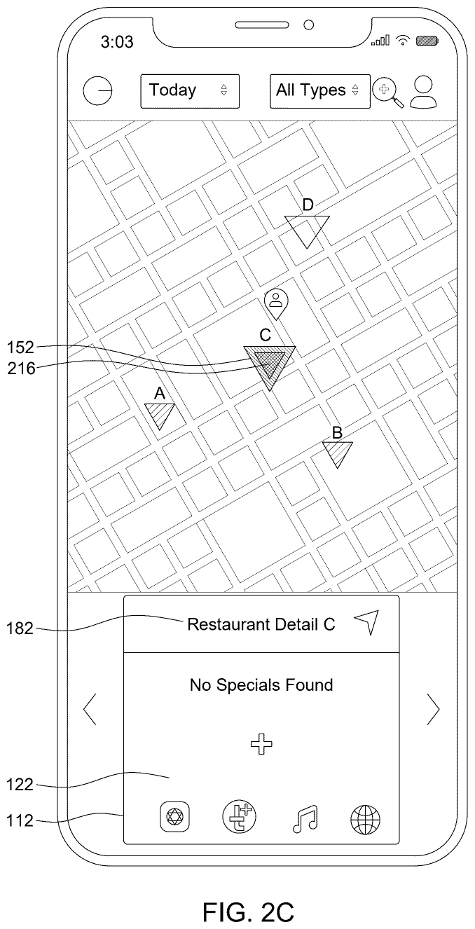

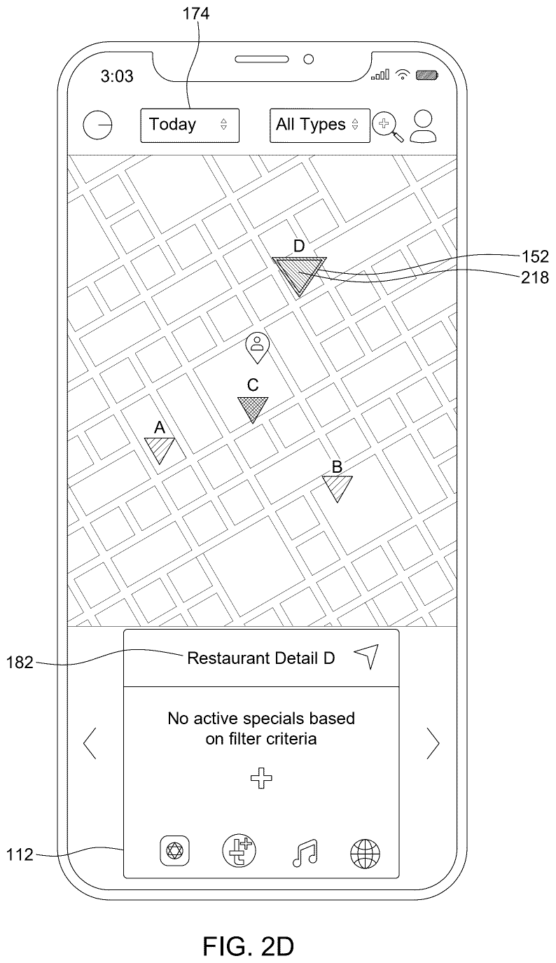

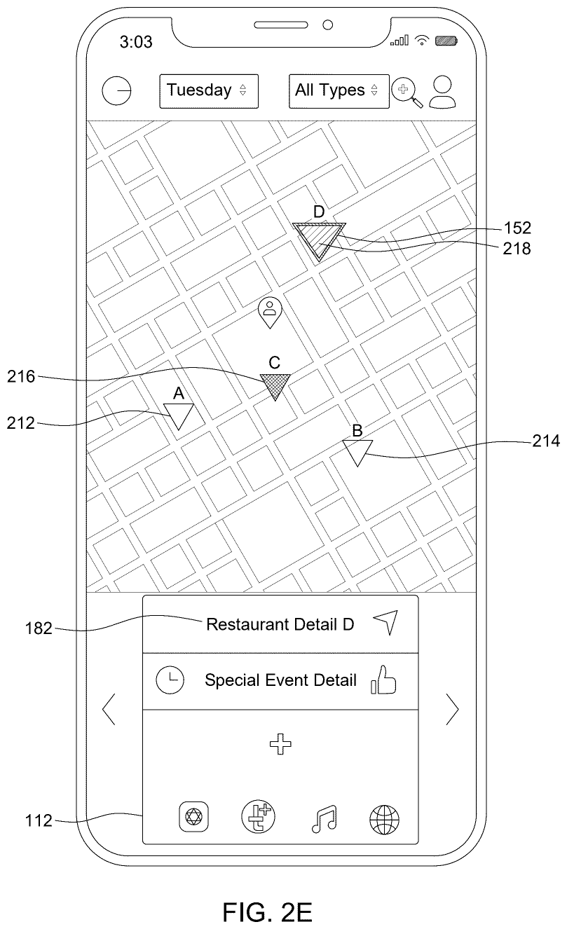

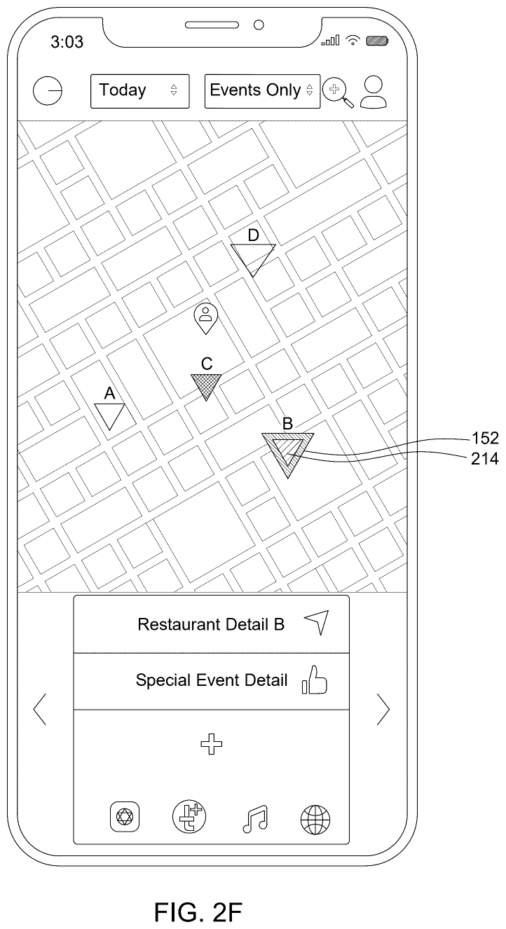

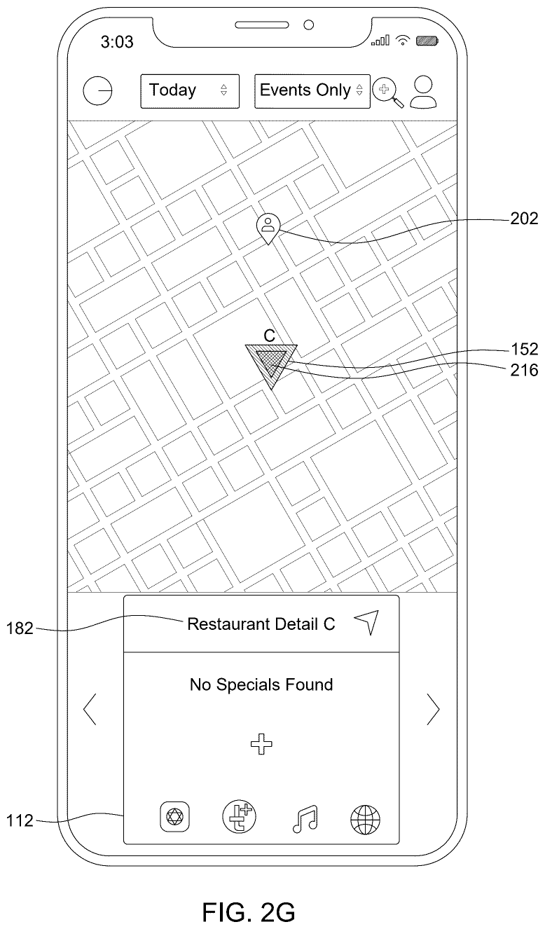

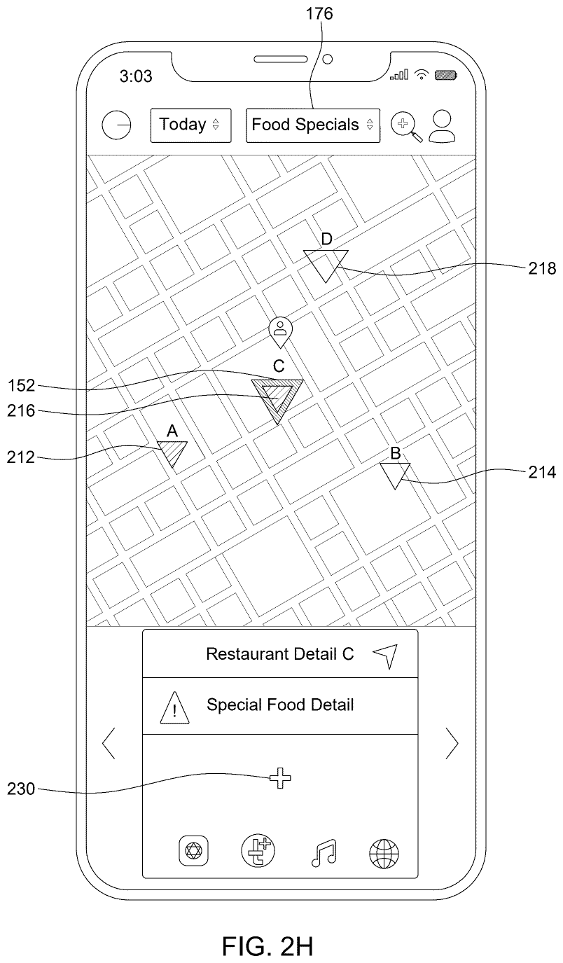

FIGS. 2A-2H are representative views of a phone app user interface for a RPAS, showing various aspects of restaurant information and customer interaction with the restaurant information of the RPAS, according to an illustrative embodiment. FIG. 2A is a representative view of a RPAS at start up, according to an illustrative embodiment. The RPAS can show the location of the customer 202 in the center of the map.

At default, the time window filter 174 can be set to display current promotions available now, and the promotion type filter 176 can be set for all promotion types. Restaurant tags 212 and 214 can have a first color indicating that the restaurants at those locations have current promotions. Restaurant tag 216 can have a second color indicating that the restaurant at that location has no known promotions. Restaurant tag 218 can have a third color indicating that the restaurant at that location has known promotions, but no current promotions. In various embodiments, restaurant tag 218 indicating that the restaurant has no current promotions can be shown as a hollow outline.

At default, when a potential customer starts the RPAS, the closest restaurant to potential customer 202 that has a current promotion can be the prime restaurant 182, and prime restaurant 182 can be highlighted with the prime tag 152 and the prime tile for that restaurant can be simultaneously shown in the prime position 112 of the carousel 110. As shown in the example of FIG. 2A, the closest restaurant with a current promotion is restaurant A, indicated by tag 212. The prime tag 152 can be shown as an outer perimeter with a different color around the smaller restaurant tag 212, and tag 212 can be the first color which indicates that restaurant A has current promotions. In various embodiments, the prime tag can be indicated as an outer perimeter, and/or can be indicated as a flashing pattern, a spinning or vibrating movement, or other means to indicate the prime tag. The tile for restaurant A that can be in the prime 112 position can display the promotion information such as the name and a description of that promotion.

In the example shown in FIG. 2A, the closest restaurant with a current promotion is restaurant A, so restaurant A has the prime tag 152 on the map, and the tile for restaurant A is shown in the prime location 112 on the carousel. The potential customer can quickly and easily see the closest current promotion to that potential customer upon start up, and can simultaneously see where that restaurant is located on the map relative to the potential customer. In various embodiments, the customer may be able to toggle the prime tile 122 to see additional information about the restaurant and/or promotions at that restaurant.

A customer can click on the tags for other restaurants, such as tag 214 indicating restaurant B. FIG. 2B shows the RPAS of FIG. 2A after the customer has clicked on the tag 214 for restaurant B, according to an illustrative embodiment. When the customer clicks tag 214 for restaurant B, restaurant B becomes the prime restaurant 182. The tile for restaurant B now moves into the prime position 112 on the carousel 110, and at the same time, the prime tag 152 is now indicating the tag 214 for restaurant B. The prime tile 122 can now display promotion information for promotions at restaurant B, and simultaneously the prime tag 152 can indicate to the customer where restaurant B shown on the prime tile 122 can be found on the map 150.

FIG. 2C shows the RPAS of FIG. 2B after a customer has clicked on the tag 216 for restaurant C, according to an illustrative embodiment. When the customer clicks on tag 216 for restaurant C, restaurant C becomes the prime restaurant 182. The tile for restaurant C now moves into the prime position 112 of carousel 110, and at the same time, the prime tag 152 is now around the tag 216 for restaurant C. The prime tile 122 can now display promotion information for promotions at restaurant C, and simultaneously the prime tag 152 can indicate to the customer where the restaurant shown on the prime tile 122 can be found on the map 150. However, as shown in FIG. 2C, restaurant C has no known promotions. This can be indicated to the customer by the color of the tag 216 for restaurant C. Simultaneously, the tile for restaurant C that is now in the prime position 112 shows that there are no known specials for restaurant C.

The customer can also click or scroll on the carousel. Scrolling the carousel can advance the carousel to the next tile. FIG. 2D shows the RPAS of FIG. 2C after a customer has scrolled the carousel to the next position, according to an illustrative embodiment. When a customer scrolls the carousel to the next position, the next tile can move into the prime position. In various embodiments, when the customer scrolls the carousel to the next position, a different restaurant, such as the next closest restaurant, can become the prime restaurant 182. As shown in the example of FIG. 2D, the next closest restaurant can be restaurant D, and restaurant D can become the prime restaurant 182. The tile for restaurant D now moves into the prime position 112 of carousel 110, and at the same time, the prime tag 152 is now around the tag 218 for restaurant D. The prime tile 122 can now display promotion information for promotions at restaurant D, and simultaneously the prime tag 152 can indicate to the customer where the restaurant shown on the prime tile 122 can be found on the map 150. However, as shown in FIG. 2D, restaurant D has no current promotions. This can be indicated to the customer by the color of the tag 218 for restaurant D. Simultaneously, the tile for restaurant D that is now in the prime position 112 shows that there are no current specials for restaurant D. However, the color of the tag 218 for restaurant D can indicate that restaurant D does have other promotions that are not active during the selected time window, and the tile for restaurant D can also indicate that restaurant D does have promotions available at other times. In various embodiments, when the prime restaurant has no current specials but does have other specials outside of the current time window, a customer may be able to toggle the tile for the prime restaurant, such as restaurant D, to find information about promotions at that restaurant that are not currently active.

A customer can adjust the time window filter 174 to see promotions outside of the current time window. FIG. 2E shows the RPAS of FIG. 2D after a customer has adjusted the time window filter, according to an illustrative embodiment. As shown in the example of FIG. 2E, the time window filter 174 has been set to Tuesday, and the RPAS is now displaying promotions that will be active on Tuesday. Restaurant D remains the prime restaurant 182, so restaurant D is still shown in the prime position of the carousel, and restaurant D still has the prime tag 152 around tag 218.

Restaurant D has a promotion that will be active on Tuesdays, so with the time window filter set for Tuesday, the tag 218 for restaurant D has now changed color, and now indicates that restaurant D has a promotion during the selected time window. Simultaneously, the tile for restaurant D that remains in the prime position 112 can show the promotions that are active at restaurant D during the selected time window. Information shown on the tile for restaurant D can include the name of the promotion, information about the promotion, and/or the time window that the promotion will be available. Tags 212 and 214 have changed color indicating that restaurant A and restaurant B do not have promotions that are available during the selected time window. The tag 216 for restaurant C has not changed, and continues to indicate that there are no known promotions for restaurant C.

A customer can adjust the promotion type filter 176 to show desired promotions, which can be all available promotions or a subset of available promotions. The RPAS can then display the promotion type selected by the customer. FIG. 2F shows the RPAS of FIG. 2E after a customer has adjusted the promotion type filter to display only events, and has returned the time window filter to the current time, according to an illustrative embodiment. In various embodiments, when a customer adjusts the promotion type filter, the RPAS can default to making the closest restaurant with a promotion that matches the promotion type filter become the prime restaurant. As shown in the example of FIG. 2F, the closest restaurant with an event during the current time window is restaurant B, so restaurant B becomes the prime restaurant 182. The prime tag 152 can be highlighting restaurant B, and the tile for restaurant B can now be in the prime position of the carousel. The tile for restaurant B now shows information for the event at restaurant B, while the prime tag simultaneously shows the customer the location of restaurant B on the map where the customer can find the event shown on restaurant B's tile that is in the prime position. The tags 212 and 218 have changed color indicating that restaurant A and restaurant D do not have events that are active during the selected time window. The tag 216 for restaurant C has not changed, and continues to indicate that there are no known promotions for restaurant C.

A customer can adjust the selected geographic area. FIG. 2G shows the RPAS of FIG. 2F after a customer has reduced the radius of the geographic area around the customer 202, according to an illustrative embodiment. As shown in the example of FIG. 2G, the customer has reduced the radius around the customer to a small enough area that only includes restaurant C. The map now shows only restaurant C, and simultaneously the carousel only has a tile for restaurant C. Restaurants outside of the selected geographic area are not shown on the map and do not have tiles on the carousel. Restaurant C is the only restaurant in the selected geographic area, and so restaurant C becomes the prime restaurant 182, although restaurant C still has no known promotions.

As will be explained more fully below, a customer can add new promotions for restaurants. By way of non-limiting example, if a customer is aware of a promotion at restaurant C that is not in the RPAS, the customer can add that promotion for restaurant C to the RPAS. FIG. 2H shows the RPAS of FIG. 2G after a customer has increased the radius of the geographic area around the customer 202 and has added a promotion to restaurant C, according to an illustrative embodiment. As shown in the example of FIG. 2H, the customer has also adjusted the promotion type filter 176 to show only food promotions. The tag 216 for restaurant C is now the color that indicates that restaurant C has a current promotion, and simultaneously the tile for restaurant C shows information about the current promotion at restaurant C. Tag 212 for restaurant A is the color that indicates that restaurant A has a current food promotion. Tags 214 and 218 are the color that indicate that restaurant B and restaurant D do not have current food promotions.

The shape, color, or other appearance of the tags 212, 214, 216, and 218 can quickly inform the potential customer at a glance which restaurants around the potential customer have active food promotions during the current time window, and where those restaurants are located relative to the potential customer. At the same time, the prime tile 122 can provide the customer with information about the promotion(s) currently being offered at the prime restaurant 182, which is simultaneously indicated on map 150 by the prime tag 152.

The potential customer can quickly click from one restaurant tag to another to learn about the promotions being offered at each restaurant. As the customer clicks on a restaurant tag, that restaurant becomes the prime restaurant, that restaurant's tile moves to the prime position, and that restaurant is indicated by the prime tag on the map, thereby allowing the customer to quickly see the promotions available at that location by viewing a description of the promotion on the prime tile while simultaneously seeing the location of that restaurant highlighted on the map by the prime tag.

The potential customer can quickly scroll the carousel, thereby moving different restaurant tiles into the prime position. This can enable the customer to quickly see and read every available promotion within the geographic area. As the customer moves different restaurant tiles into the prime position, that restaurant becomes the prime restaurant, and that restaurant is simultaneously indicated on the map by the prime tag, thereby allowing the customer to quickly swipe through available promotions, and see the location of the promotion shown in the prime location on the map while simultaneously seeing a description of the promotions available at that restaurant in the prime position.

A method for finding a promotion using the Restaurant Promotion and Advertising System may include determining a customer's geographic location, displaying a map representation of an area around the customer on a graphical user interface of a mobile communication device, and superimposing on the map location markers for restaurants within the area. The method may further include displaying a carousel interface containing tiles corresponding to the restaurants shown on the map, where each tile displays promotional information for the corresponding restaurant. The method may include receiving filter criteria from the customer, the filter criteria including at least one of a time window specification and a promotion type specification. The method may include filtering the displayed restaurants based on the filter criteria to show only restaurants having promotions that match the filter criteria. The method may include updating the visual appearance of the location markers on the map to indicate which restaurants have promotions matching the filter criteria. The method may include receiving a selection input from the customer, the selection input identifying a selected restaurant by either clicking on a location marker on the map or scrolling the carousel to position a tile in a prime position. The method may include highlighting the location marker for the selected restaurant with a prime tag on the map while simultaneously displaying the tile for the selected restaurant in the prime position of the carousel. The method may include displaying detailed promotional information for the selected restaurant on the tile in the prime position, the promotional information including a promotion title, a time window during which the promotion is available, and a detailed description of the promotion. The method can enable the customer to systematically evaluate all restaurants within the selected geographic area by scrolling through the carousel or clicking on different location markers, with the map and carousel updating synchronously to show both the geographic location and promotional details for each restaurant as it becomes the selected restaurant.

Customers can contribute to the functionality of the RPAS. They can contribute by adding new restaurants that were not in the RPAS, recording new promotions for existing restaurants, verifying promotions already in the RPAS, editing details of existing promotions, adding new details about promotions, etc. To maintain data integrity and accuracy, these contributions from customers can be subject to a verification process where other customers can verify the accuracy of the information. This participatory model can help to keep the RPAS current, accurate, relevant, and reliable. Each successful verification, edit, or new entry can reward the customer with participation points.

A customer can add new promotions to a restaurant that is already in the RPAS. In various embodiments, the customer can click somewhere on a restaurant's tile, such as, for example, the “+” icon 230 located on a restaurant's tile 120 to add promotions for that restaurant. As shown in the examples of FIG. 2H, a customer can click on the “+” icon 230 to add a promotion for the restaurant in the prime position, which in this example is restaurant C.

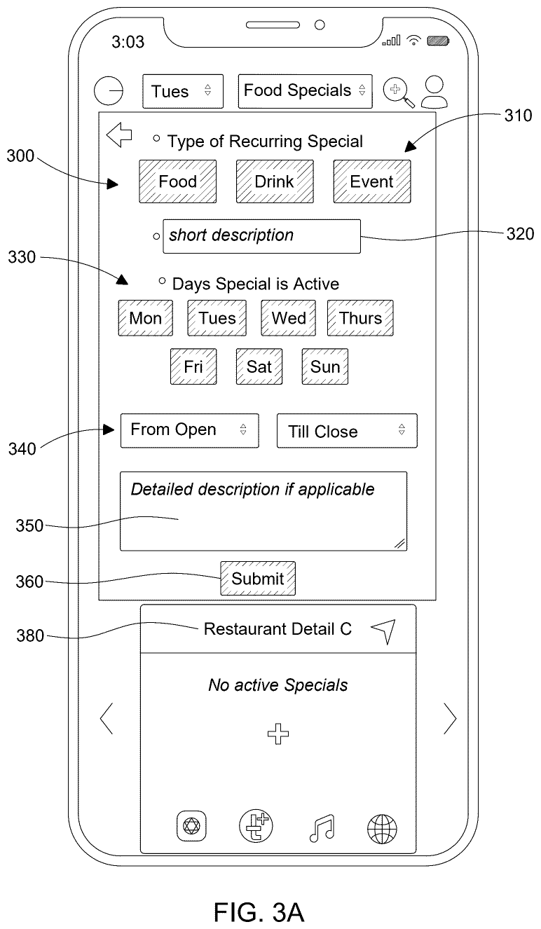

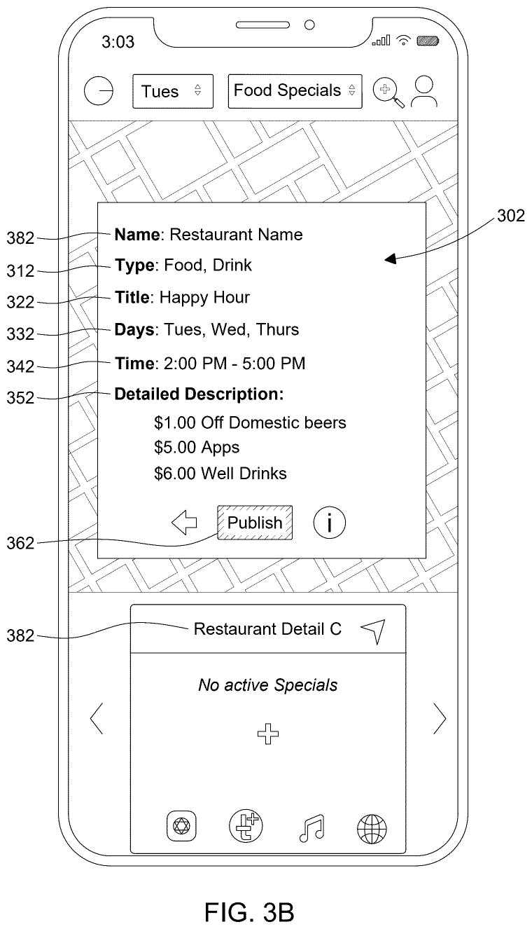

FIG. 3A is a representative view of a promotion recording interface for a recording customer, according to an illustrative embodiment. After a customer indicates a desire to record a new promotion, such as by pressing the “+” icon 230, the customer can become a recording customer. The recording customer is presented with a promotion input system that includes promotion input fields. In various embodiments, the promotion input fields can be presented to the recording customer sequentially, or the promotion input fields can be presented together, such as a promotion input pop-up screen 300. A promotion input system, such as promotion input pop-up screen 300, can present the customer with one or more input fields with closed-choice options to pick from for inputting a new promotion. The name of the restaurant 380 that is having the promotion being recorded by the recording customer can be displayed by the RPAS.

The recording customer can be presented with an input field for promotion types. The promotion type input field 310 can prompt the recording customer to select from a closed list of promotion types. The RPAS can present a closed list of options through a drop-down list, or multiple buttons such as a shown on the promotion type input area 310, or other means. The closed list of promotion type options presented to the customer can correspond to the options available in the promotion type filter 176. In this way, the recording customer is prompted to record information in a closed format that matches the categories of information that are presented by the RPAS to a potential customer who is looking for a particular promotion, and matches the way information is filtered by the RPAS for a potential customer who is looking for a particular promotion.

A recording customer can be presented with an input field for a short description or title for the promotion. As shown in FIG. 3A, title input field 320 can present a recording customer with a space to enter a short description of the promotion. The short description can have a fixed number of characters, such as 50 characters, so that the short description can correspond to, and fit within the promotion title area 130 on a tile 120.

A recording customer can be presented with an input field for selecting one or more days of the week that the promotion is available. As shown in FIG. 3A, the day of the week input field 330 can prompt the recording customer to select from a closed list of days of the week. The RPAS can present a closed list of days through a drop-down list, a clickable calendar, or multiple buttons such as a shown on the day of the week input area 330, or other means. The closed list of days presented to the recording customer can correspond to the days of the week in the time window filter 174. In this way, the recording customer is prompted to record information in a closed format that matches the categories of information that are presented by the RPAS to a potential customer who is looking for a particular promotion, and matches the categories of information filtered by the RPAS for a potential customer who is looking for a particular promotion.

A recording customer can be presented with an input field for selecting the start time and the end time for the time window when the promotion is available. As shown in FIG. 3A, the start time and end time input field 340 can prompt the recording customer to provide the start time and end time for the promotion. The RPAS can present an open field for entering time, or a drop-down menu of possible times that can include “from open” and “until close”, a scrollable set of time numbers, or other means for entering a start time and/or an end time. The time entry options for start time and end time presented to the customer can allow the promotion start time and end time to be filtered by the time window filter 174. In this way, the customer is prompted to record information in a closed format that matches the way information is presented and filtered by the RPAS for a potential customer who is looking for a particular promotion.

A recording customer can be presented with an input field for a more detailed description of the promotion. As shown in FIG. 3A, description input field 350 can present a recording customer with a space to enter a description of the promotion. In various embodiments, the description can have a fixed number of characters, so that the detailed description can correspond to, and fit within the area for a promotion description 134 on a tile 120.

As explained above and shown in FIG. 3A, the RPAS can obtain information about promotions from recording customers that future customers can easily filter and sort to find desired promotion information quickly, without the need for the RPAS to have human employees or data managers. This allows the new information about promotions to be available quickly, in real time, to future potential customers. By collecting data from current customers who are currently at a particular restaurant, having the current customers enter the promotion information in a format that can be quickly filtered and sorted by future potential customers, without the need for any employees of the RPAS to handle, enter, sort, or process the promotion information, the RPAS is able to provide real-time information to future potential customers that can include pop-up specials or other promotions that may only exist for a short time such as a couple of hours around a single mealtime on a single day. This allows potential customers to find and enjoy local promotions at local restaurants within a time frame that allows for the potential customer to research, travel, and enjoy the meal all within the short time window of a current promotion.

After a recording customer has entered the promotion information, the recording customer can submit the promotion information. In various embodiments, the recording customer can click on a submit button 360. In various embodiments, after the recording customer submits the promotion information, the RPAS can present the recording customer with a review screen. FIG. 3B is a representative view of a promotion reviewing interface for a recording customer, according to an illustrative embodiment. The RPAS can present the recording customer with an opportunity to review the promotion information that the recording customer just entered. In various embodiments, a review screen 302 can display the promotion information entered by the recording customer. The review screen may display, for example, the restaurant name 382, the promotion type(s) 312 entered by the recording customer, the title 322 entered by the recording customer, the days of the week 332 entered by the recording customer, the time of day 342 entered by the recording customer, and/or the detailed description 352 entered by the recording customer. The recording customer can review the promotion information, and can approve the information. After a recording customer has reviewed and approved the promotion information, the recording customer can publish the promotion information. In various embodiments, the recording customer can click on a publish button 362.

A recording customer can be rewarded for recording a promotion. In various embodiments, the recording customer can be rewarded with points that can be exchanged for sweepstakes or other rewards. In various embodiments, a recording customer can be rewarded with points, badges, trust scores, promotions, rank upgrades, or other rewards for recording a promotion.

The RPAS can display the promotion recorded by the recording customer, however, until the promotion information is verified by at least one verifying customer(s), the promotion can be displayed as unverified. To ensure data accuracy and integrity, a verification process can be used so that consumer submissions are verified by other customers.

A method for recording a promotion using the RPAS may include receiving a customer indication to record a new promotion for a restaurant, displaying a promotion input interface on a graphical user interface of a mobile communication device, and presenting the customer with a promotion type input field displaying closed-choice options for categorizing the promotion. The method may include receiving a customer selection of at least one promotion type from the closed-choice options, the promotion types including food, drink, and event categories. The method may include presenting the customer with a title input field for entering a short description of the promotion, the title input field having a character limit that ensures the entered title will fit within a promotion title display area on restaurant tiles. The method may include receiving a customer-entered promotion title through the title input field. The method may include presenting the customer with a day selection input field displaying closed-choice options for days of the week, the day selection input field enabling selection of one or more days when the promotion is available. The method may include receiving a customer selection of at least one day of the week through the day selection input field. The method may include presenting the customer with a time window input field for specifying start and end times when the promotion is available during the selected days, the time window input field including dropdown selectors with preset options and specific time selections. The method may include receiving customer-entered start and end times through the time window input field. The method may include presenting the customer with a detailed description input field for entering comprehensive information about the promotion, the detailed description input field having a character limit that ensures the entered description will fit within a promotion description display area on restaurant tiles. The method may include receiving a customer-entered detailed description through the detailed description input field. The method may include receiving a customer submission of the entered promotion information through activation of a submit button. The method may include displaying a promotion review screen showing all entered promotion information in a consolidated view, enabling the recording customer to verify accuracy before publication. The method may include receiving a customer confirmation of the promotion information through activation of a publish button. The method may include processing the submitted promotion information and assigning initial authentication points based on a trust score of the recording customer. The method may include making the promotion information immediately available for display to other customers with an unverified status indicator, enabling real-time dissemination of newly discovered promotional information while maintaining transparency about verification status. The method may include initiating a community verification process for the newly submitted promotion, enabling other customers to verify the accuracy of the promotion information and contribute additional authentication points based on their respective trust score.

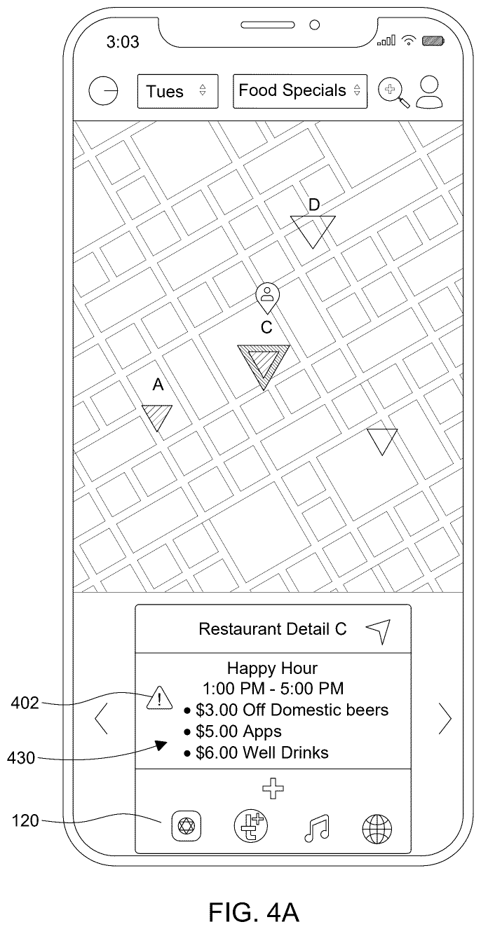

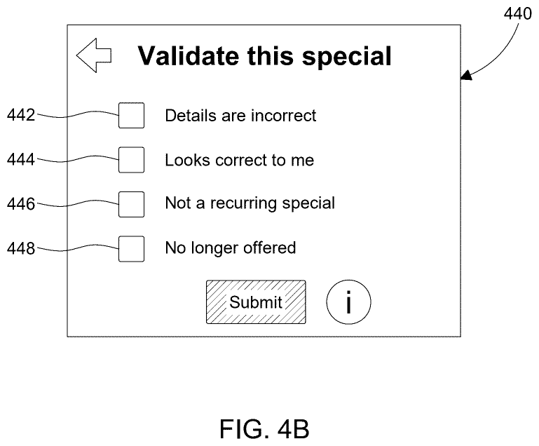

FIG. 4A is a representative view of a RPAS showing an unverified promotion, according to an illustrative embodiment. When a recording customer publishes a promotion, the tile 120 showing the promotion can be displayed with an unverified indicator 402. The unverified indicator can serve two purposes. First, the unverified indicator 402 can warn potential customers that the listed promotion 430 could possibly be inaccurate. Second, the unverified indicator can inform a customer that they can become a verifying customer. A customer can indicate a desire to become a verifying customer by, for example, clicking on the unverified indicator, clicking on an invitation to become a verifying customer, or other means.

FIG. 4B is a representative view of a promotion verifying interface for a verifying customer, according to an illustrative embodiment. After a customer indicates a desire to verify a new promotion, such as by pressing the unverified indicator icon 402, the customer can become a verifying customer. The verifying customer can be presented with a verification screen 440. The promotion verification screen 440 can present the customer with several closed-choice options to pick from for verifying a new promotion. The verifying customer can be presented with options that can include a choice for verifying that the new promotion is correct 444, and a choice for rejecting the new promotion as incorrect 442. In various embodiments, the verifying customer can be presented with additional options such as, for example, an option to indicate that some information about the new promotion is correct, but the new promotion was incorrectly entered as a recurring promotion 446. In various embodiments, the verifying customer can be presented with additional options such as, for example, an option to indicate that some information about the new promotion is correct, but the new promotion has been discontinued or is not currently being offered 448. Various other options to report accuracy or inaccuracies in an unverified promotion may be presented to a verifying customer.

When a sufficient number of verifying customer select the option to verify that the new promotion is correct, the new promotion can become a verified promotion. The number of verifying customers required to verify a promotion can vary. In various embodiments, the number of verifying customers can be a predetermined number, such as two or three, however, more or fewer verifying customers may be required. In various embodiments, the sufficient number can be a predetermined number, or can be based on trust scores, as explained more fully below, or other ways to determine the sufficient number. When the promotion becomes a verified promotion, it will be displayed to potential customers as a known promotion without the unverified indicator.

In various embodiments, the number of verifying customers required can vary based on the trust score of the recording customer. A customer can earn increases in their trust score by recording promotions that are verified by others. A customer can earn increases in their trust score by accurately verifying new promotions that have been recorded by recording customers. As a recording customer records more promotions and/or verifies more promotions, that customer's trust score can increase. As the customer's trust score increases, new promotions recorded by that customer may require fewer verifying customers to verify the new promotion. As a customer's trust score increases, new promotions verified by that customer may require fewer additional verifications from additional verifying customers. As customers earn increasing trust scores, they may receive increasing levels of rewards for each new promotion they record and/or verify, because fewer verifications are required after those customers with higher trust scores record and/or verify new promotions.

In various embodiments, a system of authenticating points may be used. By way of non-limiting example, a promotion may require a predetermined number of authenticating points before a special is considered to be a verified known special. When a recording customer enters a new promotion, the new promotion can be assigned a number of authenticating points. The number of authenticating points assigned when the new promotion is first recorded can vary depending on the trust score of the recording customer. When a recording customer with a higher trust score enters a new promotion, that new promotion can start out with a higher number of authenticating points than a promotion recorded by a recording customer with a lower trust score. Each time a verifying customer agrees with, or verifies, the new promotion, that new promotion receives additional authenticating points. When a verifying customer with a higher trust score verifies the promotion, the new promotion can receive a higher number of authentication points compared to a verification from a customer with a lower trust score. A predetermined minimum number of authentication points may be required for a new promotion to become a verified, known promotion.

If a verifying customer selects an option such as 446 to indicate that a promotion is not recurring, or an option such as 448 to indicate that the promotion is no longer offered, the RPAS can remove the new special, remove the recurring status of the new special, or the RPAS can ask additional customers to verify whether the recording customer was correct about the promotion, or whether the verifying customer was correct in saying the recording customer was incorrect.

In various embodiments, when a verifying customer selects an option such as 448 to indicate that the promotion is no longer offered, the new promotion may lose authentication points. The number of points lost can depend on the trust score of the verifying customer who indicated that the new promotion information was incorrect. In various embodiments, a new promotion may be rejected or removed if the authentication point score falls below a predetermined rejection threshold such as, for example, a threshold of zero.

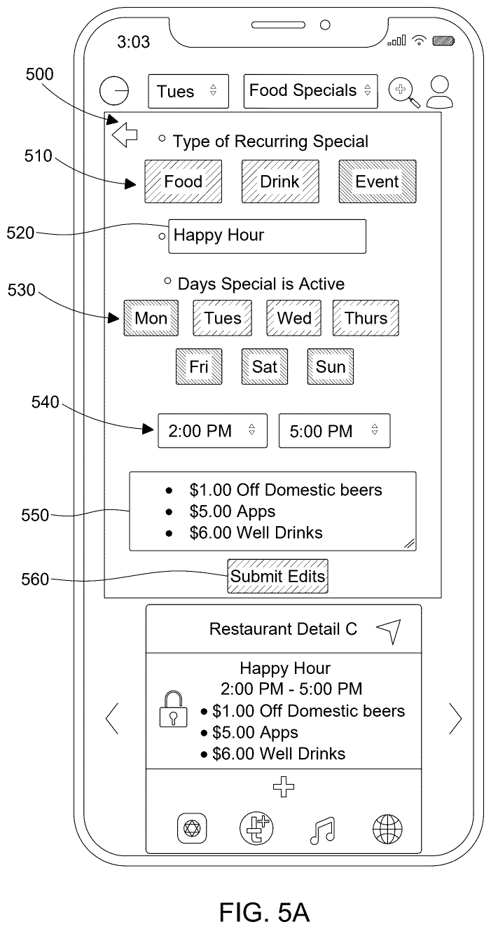

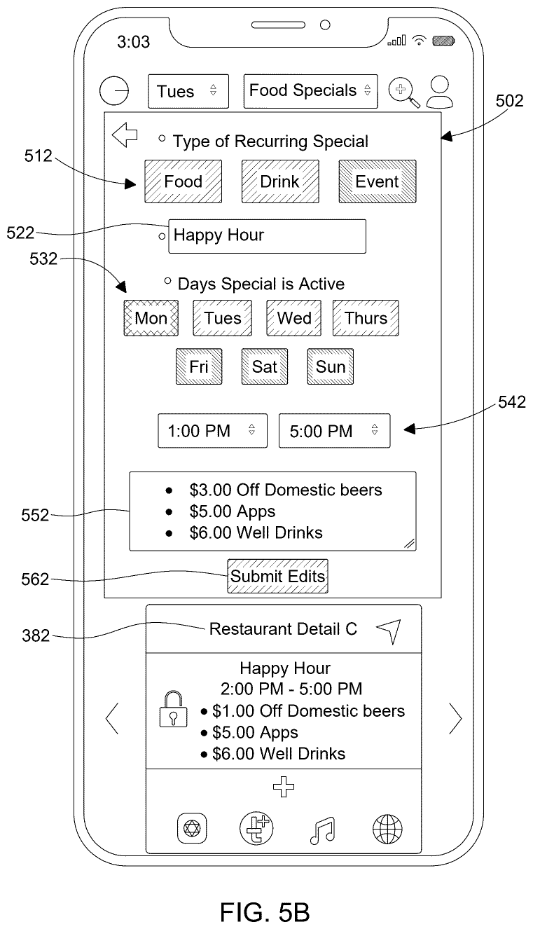

If a verifying customer selects an option such as 442 to indicate that some details are incorrect, the RPAS may present the verifying customer with a promotion correction interface, thereby allowing the verifying customer to become a correcting customer. FIG. 5A is a representative view of a promotion correction system for a correcting customer, according to an illustrative embodiment. In various embodiments, a promotion correction screen 500 can present the correcting customer with the opportunity to correct inaccurate promotion information. In various embodiments, a promotion correction screen 500 can present the correcting customer with one or more input fields with closed-choice options to pick from for correcting information about a new promotion. In various embodiments, the promotion correction screen 500 can resemble the promotion input screen 300 from FIG. 3A and/or can present the correcting customer with similar closed lists of similar closed options as were presented to the recording customer in the promotion input screen 300.

In various embodiments, the promotion correction screen 500 can show the information entered by the recording customer, and invite the correcting customer to correct inaccuracies. By way of non-limiting example, the promotion correction screen 500 can show a promotion type area 510 that can highlight the types of promotions selected by the recording customer, and the correcting customer can click on the promotion types to make corrections. Similarly, the promotion correction screen 500 can show a title field 520, day of the week field 530, start time and end time field 540, and/or description field 550. The correcting customer can click on any inaccurate information and make appropriate changes. After the correcting customer is satisfied that all promotion information has been accurately corrected, the correcting customer can submit the corrected promotion information. In various embodiments, the correcting customer can click on a submit edits button 560.

In various embodiments, after the correcting customer submits the corrected promotion information, the RPAS can present the correcting customer with a correction review screen. FIG. 5B is a representative view of a correction reviewing interface for a correcting customer, according to an illustrative embodiment. The RPAS can present the correcting customer with an opportunity to review the corrected promotion information. In various embodiments, a correction review interface 502 can display the corrected promotion information entered by the correcting customer. In various embodiments, the correction review screen 502 can highlight information corrected by the correcting customer. In various embodiments, the correction review screen can display information accurately entered by the recording customer on one color, and information that was corrected by the correcting customer in another color.

The correction review interface 502 may display, for example, the restaurant name 382, a promotion type(s) field 512 that can highlight corrected promotion type information, a corrected title field 522 that can highlight corrected title information, a corrected day of the week field 532 that can highlight corrected day of the week information, a corrected time of day field 542 that can highlight corrected time of day information, and/or a corrected detailed description field 552 that can highlight corrected detailed description information. The correcting customer can review the corrected promotion information, and can approve the information. After a correcting customer has reviewed and approved the corrected promotion information, the correcting customer can publish the corrected promotion information. In various embodiments, the correcting customer can click on a publish edits button 562.

A verifying customer can be rewarded for verifying and/or correcting a promotion. In various embodiments, the verifying customer can be rewarded with points that can be exchanged for sweepstakes or other rewards. In various embodiments, a verifying customer can be rewarded with points, badges, trust scores, promotions, rank upgrades, or other rewards for verifying and/or correcting a promotion.

The RPAS can use recording customers and verifying customers to maintain a current and accurate set of information about local restaurants and promotions offered at the local restaurants. The system can use a crowdsourcing recording model and a crowdsourcing verification model to ensure the promotions displayed by the RPAS are continuously checked, updated, and verified by the local community of customers.

By way of non-limiting examples, customers can earn points, badges, and/or a trust score based on the frequency and accuracy of their contributions. A high trust score indicates that a customer's contributions are reliable, increasing the credibility of the data. Higher trust scores may lead to increased rank and increased rewards.

In various embodiments, recording customers can add new restaurants to the RPAS. Recording customers may be able to search for restaurants that are not currently in the RPAS and add them to the RPAS service. Recording customers can search for restaurants using geolocation, name, address, or other means known to those of skill in the art for identifying an existing business. In various embodiments, the RPAS may access data from third party business listings, including third party map services, and/or other listings of existing businesses. After a restaurant is found, a customer can add the restaurant to the RPAS. Adding the restaurant to the RPAS can include adding the restaurant name, address, map coordinates, location information, business hours, and/or other information about the restaurant. Information added to the RPAS can include information added manually by the customer and/or information pulled into the RPAS from other third-party business listing.

In various embodiments, a recording customer may only need to look up and identify a restaurant that can be found on third party business listings, including third party map services, and/or other listings of existing businesses. After identifying the restaurant, the RPAS can use restaurant information found on the third-party business listing to create the new restaurant listing. After the recording customer has identified a restaurant on a third-party business listing, the recording customer can verify that all of the restaurant information provided by the third-party business listing is accurate.

In various embodiments, a recording customer may record all of the restaurant information without searching third party business listings or importing information from third party business listings. The customer may be prompted to record information such as the restaurant's name, address, map location, and/or hours of business. In various embodiments, the recording customer may be prompted to enter additional information about the new restaurant, such as social media links, website links, or other additional information.

A recording customer can be rewarded for recording a new restaurant. In various embodiments, the recording customer can be rewarded with points that can be exchanged for sweepstakes or other rewards. In various embodiments, a recording customer can be rewarded with points, badges, trust scores, promotions, rank upgrades, or other rewards for recording a new restaurant. This system of rewards encourages users to actively engage with the RPAS.

The RPAS can display the new restaurant recorded by the recording customer, however, until the new restaurant information is verified by at least one verifying customer(s), the restaurant can be displayed as unverified. To ensure data accuracy and integrity, a verification process can be used so that consumer submissions are verified by other customers.

A verification process can be used by the RPAS to verify the accuracy of new restaurants added by recording customers. The verification process for new restaurants can be similar to the verification process used for new promotions. In various embodiments, the verification process can include assigning authentication points based on the trust score of the recording customer. Recording customers with higher trust scores can contribute more authentication points to a new restaurant listing than recording customers with lower trust scores.

After a new restaurant listing has been created by a recording customer, the new restaurant listing can enter a community-based verification process, similar to the community-based verification process used by the RPAS to verify new promotions. Verifying customers are able to review and verify the new restaurant listing. Verifying customers may have the option to approve the new restaurant listing, partially approve portions of the new restaurant listing while flagging other portions of the new listing as inaccurate, or flag the entire new restaurant listing as inaccurate. The new listing can gain or lose authentication points depending on whether the verifying customer verifies the new listing as accurate or flags the new listing as inaccurate or partially inaccurate. The verifying customer's trust score can affect the number of authentication points gained or lost for the new restaurant listing. After the new restaurant accumulates a predetermined number of authentication points, the new restaurant can become a verified, known restaurant in the RPAS.

A verifying customer can be rewarded for verifying and/or correcting a new restaurant listing. In various embodiments, the verifying customer can be rewarded with points that can be exchanged for sweepstakes or other rewards. In various embodiments, a verifying customer can be rewarded with points, badges, trust scores, promotions, rank upgrades, or other rewards for verifying and/or correcting a promotion. This system of rewards encourages users to actively engage with the RPAS.

In various embodiments, an RPAS can allow customers to suggest corrections to existing listings. Corrections to existing listings can include updating the hours of operation, name, status, description, social media links, address, and/or other restaurant information. These updates can undergo the same community-based verification process to ensure ongoing accuracy of all information on the RPAS.

The RPAS can use recording customers and verifying customers to maintain a current and accurate set of information about local restaurants and promotions offered at the local restaurants. The system can use a crowdsourcing recording model and a crowdsourcing verification model to ensure the restaurants displayed by the RPAS are continuously checked, updated, and verified by the local community of customers. Through this community-based recording and verifying system, the RPAS can help the public to play an active role in managing and updating restaurant listings and promotions.

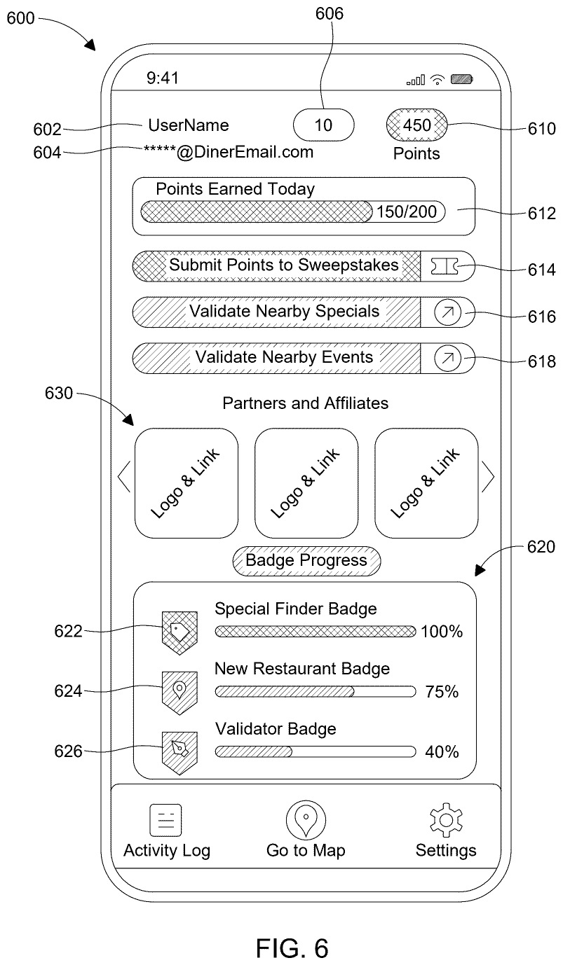

FIG. 6 is a representative view of a customer dashboard, according to an illustrative embodiment. A customer dashboard 600 can display information about a particular customer to that customer, such as the customer's points, trust score, etc. A customer dashboard 600 can show various information about a customer and/or a customer's account. By way of non-limiting examples, a customer dashboard can display a customer's name 602, customer's ID or email 604, and/or a customer's trust score 606.

By way of non-limiting examples, a customer dashboard can display a customer's points balance 610 showing points that the customer has earned by recording and/or verifying specials. A customer dashboard can have a recent points area 612 that can show the number of reward points that a customer has earned in a recent period, such as points earned today or this week. A customer dashboard can have a sweepstakes entry option 614 to trade reward points for entries into a sweepstakes. In various embodiments, the RPAS may offer promotions such as gift cards or other prizes that can be won through a sweepstakes, and reward points can be traded for entry into those sweepstakes. A customer dashboard can have verification options, such as a verify nearby specials option 616 and/or a verify nearby events option 618. These verification options can provide a customer with an opportunity to verify various promotions in the customer's selected geographic area that have been recorded but not yet verified. In various embodiments, a customer dashboard may also have an advertising area 630 for sponsors to purchase paid advertising, and the revenue from that sponsor-paid advertising can be used to purchase gift cards or other rewards that can be won in the sweepstakes.

By way of non-limiting example, a customer can earn badges and rewards for various contributions including, but not limited to, adding new restaurants that were not in the RPAS, recording new promotions that were not in the RPAS, verifying promotions that were recorded in the RPAS but needed verification, and/or identifying incorrect promotion information or incorrect restaurant information. In various embodiments, a customer can earn points that can be traded for entry into a sweepstakes or other rewards through various contributions such as adding new restaurants, recording new promotions, verifying unverified promotions, and/or identifying incorrect information in the RPAS, and those points can be shown in the reward points balance 610.

In various embodiments, a customer can earn badges through various contributions such as adding new restaurants, recording new promotions, verifying unverified promotions, and/or identifying incorrect information in the PRAS. As consumers engage more with the platform by verifying, editing, or adding new records, they can earn badges and increase the rank of those badges. Those badges, and the progress towards those badges can be shown in a badge area 620. Badge area 620 can show collected badges and/or progress towards badges such as, for example, badge for recording new promotions 622, a badge for adding new restaurants 624, and/or a badge for verifying promotions 626. In various embodiments, a customer who contributes by listing new promotions and/or verifying listings provided by other customers can earn a badge, such as a “Top Contributor” badge after adding multiple verified events and specials. Various other badges may be possible. Increased badge levels can unlock various additional perks, app features, and/or discounts within the RPAS. In various embodiments, the RPAS can use a gamified approach with points and badges that can encourage ongoing engagement and can reward customers for their efforts. This can incentivize customers to keep the RPAS updated and accurate, without the need for paid employees or data entry personal for the RPAS. Points and badges can be separate, and can result in customers benefiting from and being incentivized by multiple reward systems, including a tiered reward system.

The RPAS can foster a community-based environment that emphasizes user-generated content and engagement. Customers are encouraged to contribute by updating and verifying specials and events, ensuring that the platform remains current and relevant. This community-driven model not only benefits customers by providing accurate, up-to-date information but also helps restaurants engage with their customers on a deeper level.

Customers can submit information about various restaurants using the above recording process. The recording process used by customers to submit information about restaurants and/or promotions involves verification by other customers. Restaurant owners can submit information about their own restaurant and/or the promotions at their own restaurant using a registration process, explained more fully below. The registration process used by restaurant owners to submit information about their own restaurant and/or their own promotions does not require verification, and can be registered unilaterally by the restaurant owner.

In various embodiments, restaurant owners can manage their public profiles, and control the promotions displayed for their restaurants. Restaurant owners can purchase a subscription or membership giving them the option to take control of their restaurant's profile within the RPAS. By opting into the system, restaurant owners can optionally lock down their restaurant's information, so that only that restaurant's owner(s) can register and/or update the promotions shown for that restaurant, or otherwise contribute to the listing in any way. This can allow a restaurant owner to ensure that their promotions and other details are accurately represented. Restaurant owners can take control of their own restaurant's listings, update and manage all recurring events and specials, reactive old specials, and use the system to monitor event interest levels. Owners can update their promotions regularly, or submit them once and forget them, depending on their needs. The RPAS allows restaurant owners to register a weekly repeating promotion one time, and the RPAS can show the promotion as being available during the same time window every week in perpetuity until the restaurant owner changes or cancels the promotion. This flexibility allows restaurants to maintain a strong presence on the platform with minimal effort.

As described above, the term “restaurant owner” can refer to any person or persons who owns a restaurant, manages a restaurant, does marketing for a restaurant, or anyone has a duty or interest in increasing customer traffic to a particular restaurant. In various embodiments, the RPAS, and a restaurant owner's subscription on the RPAS, can include various levels of authority for different restaurant owners. These various levels of authority can be referred to as authority grades. In various embodiments, these various authority grades can include a subscription owner who can be the highest authority grade. The subscription owner may be the highest-ranking individual in a restaurant's ownership and/or management hierarchy. In various embodiments, the authority grades can include a general manager authority grade and a daily manager authority grade. By way of non-limiting example, the general manager authority grade may have the authority to update specials or handle credits/subscriptions, however, various authority grades, such as the general manger authority grade, may not have access to sensitive information.

In various embodiments, the subscription owner authority grade can assign permissions to various lower authority grades, such as deciding which authority grade has the ability to update promotions or offer one-time ad-hoc specials. This system of limited authority allows the subscription owner to provide access to employees and authority levels on a case-by-case analysis. This allows the subscription owner to empower some or all employees to make decisions regarding the restaurants information and promotions on the RPAS, limiting access to other decision-making privileges and/or access to sensitive information. This allows the staff to perform tasks delegated to them without needing constant approval from the subscription owner, thereby improving efficiency. A subscription owner may be able to adjust permissions quickly as roles change or for special occasions, thereby ensuring that everyone has the right permissions to help the restaurant run smoothly.

Restaurant owners who take control of their own restaurant's listings can ensure that all restaurant information and promotion information are always listed accurately. Restaurant owners who take control of their own restaurant's listings can also have changes to existing promotions, new promotions, and/or one-time promotions be displayed on the RPAS correctly and immediately without waiting for a verification process. In addition to allowing restaurant owners to register and display recurring promotions, restaurant owners can register ad hoc, one-time specials and events, and can use one-time advertising. This feature allows restaurants to offer unique promotions to consumers in real-time, having those promotions shown to customers immediately.

This enables a restaurant owner to, for example, decide spontaneously to run a one-time promotion on a day when his business is slow, and have that one-time promotion appear on the RPAS immediately, in real time. This allows the restaurant owner to provide potential customers with the new promotion information immediately, potentially at the moment that the potential customers are evaluating their options for restaurants to visit. This ability to provide immediate, real-time new promotion information to potential customers can allow the restaurant owner to adjust the restaurant's business model for that day, or even for a limited time window of that day, immediately and in real-time, in response to current business conditions, such as, for example, customer density, weather patterns, customer behavior, availability of particular ingredients, or other possible factors that may contribute to a restaurant owner's desire to adjust the business plan for a short period of time in response to real-time conditions. The restaurant owner can make immediate changes to a promotion, and the changes can be effective on the RPAS immediately. The RPAS can allow the restaurant owner to notify potential customers immediately about the ad-hoc special, thereby driving a quick influx of customers coming in for the ad-hoc promotion. Since customers are seeking deals based on what's happening now, restaurant owners can benefit from instant visibility and interaction.

Restaurant promotions can be highly time-sensitive, and any verification process can delay the release of an immediate special. Any delay of the release of an immediate special, even as a matter of minutes, can reduce the number of potential customers who are made aware of that day's ad-hoc promotion in time to influence that potential customer's dining decisions. The RPAS described herein allows a restaurant owner to update a new promotion on the platform and have it immediately available to be seen by potential customers throughout that restaurant's surrounding area. The RPAS can also allow the restaurant owner to send push notifications to targeted potential clients about promotions, including one-time specials or events, within seconds of registering the promotion on the RPAS.

The RPAS can send push notifications to the customer, including but not limited to, information about new restaurants, previously existing restaurants, new promotions, and previously existing promotions. This may be configured by the consumer so that the RPAS sends push notifications to the consumer that meet that consumer's pre-determined criteria. In various embodiments, a restaurant owner may also be able to choose to send push notifications to customers when the notifications meet a customer's criteria. In various embodiments, the RPAS can learn customer preferences, and can provide restaurant owners with an opportunity to send targeted advertising to customers based on customer preferences and past choices, as well as geographic locations.

The RPAS can allow restaurants to engage with local customers who have expressed specific interests in their offerings. This targeted approach can ensure that marketing efforts are more effective, as promotional messages are delivered directly to those who are most likely to act on them. This not only increases engagement but also builds stronger customer loyalty by delivering relevant and timely content.

Push notifications can allow a restaurant owner to promote one-time specials or events. Push notifications can be used by a restaurant owner to alert customers to new specials, restaurant listings, and events based on their current location. In various embodiments, push notifications can be triggered by the consumer's proximity to participating restaurants and/or by the timing of newly published events and specials, ensuring that customers are informed of relevant opportunities as they become available. The push notification system can enhance customer engagement by providing timely and location-based alerts, and encouraging spontaneous participation in dining and social activities.

The RPAS can allow restaurant owners to connect directly with customers without the need to navigate complex and costly advertising ecosystems. By cutting out the pay-to-play advertising platforms, the RPAS can allow restaurant owners to engage with customers in a more meaningful and cost-effective manner. This direct connection can foster stronger relationships between customers and restaurants, leading to increased loyalty and repeat business.

Restaurant owners can have their restaurant and their promotions shown on the RPAS on equal footing with other restaurants, regardless of the size of the various restaurants. Restaurant owners can also have their restaurants and their promotions shown on the RPAS on equal footing with other restaurants regardless of whether or not a particular restaurant chooses to pay for a subscription to the RPAS. All restaurants and their promotions can be shown equally regardless of the size or marketing budget of any restaurant.

A restaurant owner can provide targeted advertisements to customers within a specific geographic region. This feature can allow for precise targeting and can maximize the effectiveness of promotional efforts. A restaurant owner can send targeted notifications to specific customer groups based on those customers' preferences, filters, and/or past habits, as well as geographic location. This allows a restaurant owner to target exactly the right customer with a form of targeted advertising, when that customer is within the geographic region of that restaurant. The restaurant owner can further target specific groups of customers by limiting the targeted advertising to potential customers who are currently using the RPAS to look for restaurants in that potential customer's area that are offering promotions. By targeting to potential customers who are using the RPAS and who are in proximity to the restaurant, restaurant owners can significantly improve the likelihood of immediate engagement with that customer.

With the RPAS, restaurant owners can provide customers with information about the restaurant's promotions without the need for a large marketing budget. is particularly beneficial for smaller, independent restaurants that may not have the resources to compete on advertising platforms that prioritize paid visibility. This allows restaurant owners to effectively reach and engage their target customers without paying for advertising to be displayed to customers outside of the geographic area of the restaurant.

A restaurant owner can list promotions including one-time specials and events quickly, thereby ensuring relevant customers and potential customers are aware of the various promotions as they are being offered. A restaurant owner can track how successful each promotion is, and can assess which promotions generate the best profit. A restaurant owner can also evaluate the success of past promotions and can re-activate previous promotions quickly. A restaurant owner who determines that a one-time promotion was successful can quickly convert one-time specials and events into recurring promotions.

In various embodiments, the RPAS can allow a restaurant owner to provide a link for customers to sign up for loyalty programs. A restaurant owner can provide a link to a customer loyalty program enrollment page, and the RPAS can allow customers to sign up for the restaurant's loyalty program by clicking that link. The restaurant owner can provide a link for customers to visit various social media pages or other websites, optionally including third party websites, that can increase brand exposure for the restaurant and help with customer retention. A restaurant owner can provide a link to social media pages or other websites, and the RPAS can allow the customers to visit those social media pages and/or other websites by clicking those links.

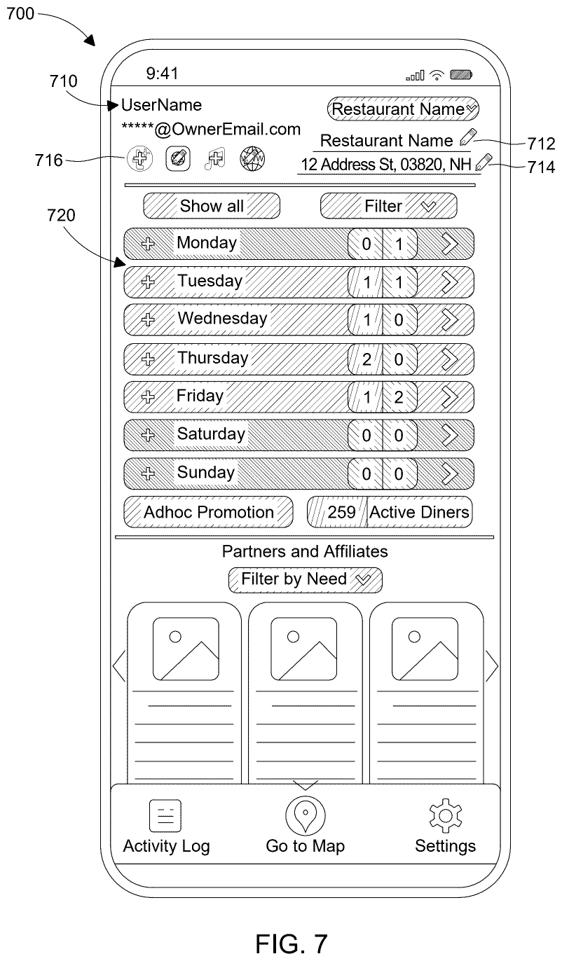

FIG. 7 is a representative view of a restaurant owner dashboard and promotion input interface, according to an illustrative embodiment. The RPAS can provide comprehensive management tools available to restaurant owners for controlling their establishment's information and promotional content within the RPAS. In various embodiments, a restaurant owner can have an exclusive right to control anything or everything that is displayed on the RPAS regarding that owner's restaurant. A restaurant owner can use a restaurant owner dashboard 700 to control information about the restaurant and the restaurant's promotions.

In the example shown in FIG. 7, a restaurant owner dashboard 700 can have a restaurant information panel 710. The restaurant information panel can allow the restaurant owner to list and/or edit the restaurant name 712, the restaurant address 714, and provide various links 716 including links to the restaurant's website, links to loyalty program enrollment pages, links to third party websites, social media websites, etc.

The restaurant owner dashboard 700 can allow the restaurant owner to register recurring promotions on certain days of the week. As shown in the example of FIG. 7, a recurring promotion area 720 can allow a restaurant owner to register a recurring promotion for a particular day of the week by clicking on that day of the week, however, various interfaces are possible that would allow a restaurant owner to register recurring specials. After a restaurant owner has indicated a desire to register a recurring promotion, such as by clicking in the recurring promotion area 720, the RPAS can present the restaurant owner with a recurring special registration screen.

An Ad hoc promotion section can enable restaurant owners to create and manage special promotions that are not part of the regular weekly recurring schedule, supporting the ability to respond to real-time business conditions with immediate promotional offerings.

Navigation elements at the bottom of the screen include Activity Log, Go to Map, and Settings buttons, providing restaurant owners with access to additional system functions. The Activity Log button enables owners to review their promotional history and customer engagement metrics, the Go to Map button allows owners to view their restaurant's appearance in the customer-facing interface, and the Settings button provides access to account configuration options.

The restaurant owner dashboard serves multiple functions within the RPAS ecosystem. By consolidating restaurant information management, recurring promotion scheduling, and ad hoc promotion creation in a single interface, the dashboard provides restaurant owners with comprehensive control over their establishment's presence in the system. This centralized management capability enables restaurant owners to efficiently maintain accurate restaurant information while managing both recurring and one-time promotional offerings.

The day-by-day promotion display provides restaurant owners with immediate visibility into their weekly promotional schedule, enabling them to identify gaps in their promotional calendar and ensure consistent customer engagement throughout the week. The numerical indicators for each day allow owners to quickly assess their promotional coverage and make informed decisions about where to add new promotions to maximize customer attraction.

The ability to register recurring promotions that automatically repeat each week eliminates the need for restaurant owners to repeatedly enter the same promotional information, significantly reducing the time and effort required to maintain an active promotional presence. This efficiency enables restaurant owners to set up their weekly promotional schedule once and then focus on their core business operations, with the option to make adjustments or add ad hoc promotions as needed.

The ad hoc promotion capability provides restaurant owners with the flexibility to respond to real-time business conditions by creating immediate promotional offerings. When business is slow or when special circumstances arise, restaurant owners can quickly create one-time promotions that become immediately visible to customers in the geographic area, driving rapid customer response without requiring advance planning or repeated promotional scheduling.

The restaurant owner dashboard enables efficient management of promotional content while maintaining the standardized format that ensures compatibility with the customer-facing filtering and display capabilities. By providing restaurant owners with direct control over their promotional information through a structured interface, the system ensures that owner-submitted promotions integrate seamlessly with customer-submitted promotions, creating a cohesive platform that serves both restaurant owners and customers effectively while maintaining real-time accuracy and comprehensive promotional coverage.

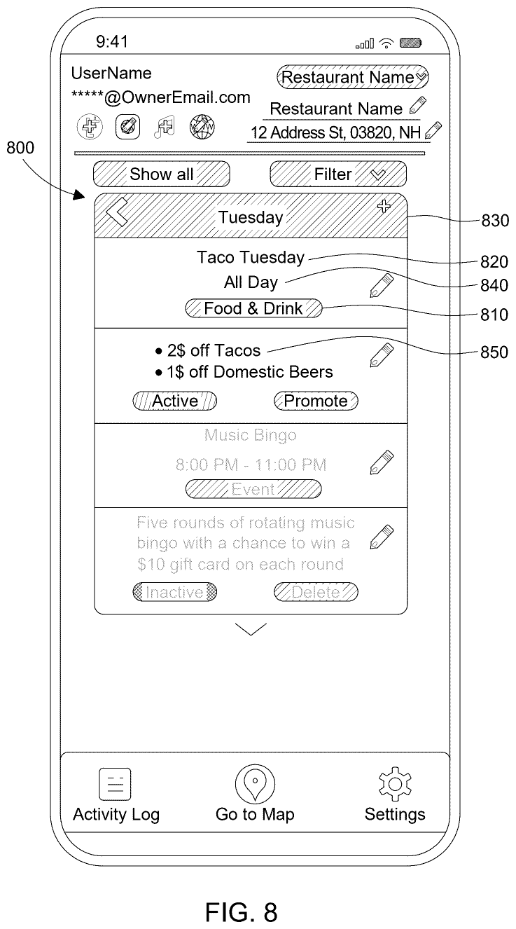

FIG. 8 is a representative view of a restaurant owner promotion registration system, according to an illustrative embodiment. Similar to a customer's promotion recording screen, a restaurant owner promotion registration screen 800 can present the restaurant owner with closed-choice options for entering a new promotion or editing an existing promotion.

The restaurant owner dashboard can include, for example, an input field for a promotion type. The promotion type input field 810 can prompt the restaurant owner to select from a closed list of promotion types. The RPAS can present a closed list of options through a drop-down list, multiple buttons, or other means. The closed list of promotion type options presented to the restaurant owner can correspond to the options available in the promotion type filter 176. In this way, the restaurant owner is prompted to register information in a closed format that matches the categories of information that are presented by the RPAS to a potential customer who is looking for a particular promotion, and matches the way information is filtered by the RPAS for a potential customer who is looking for a particular promotion.

A restaurant owner can be presented with an input field for a short description or title for the promotion. As shown in FIG. 8, title input field 820 can present a restaurant owner with a space to enter a short description of the promotion. The short description can have a fixed number of characters, such as 50 characters, so that the short description can correspond to, and fit within the promotion title area 130 on a tile 120.

A restaurant owner can be presented with an input field for selecting one or more days of the week that the promotion is available. The day of the week input field 830 can allow the restaurant owner to select from a closed list of days of the week. The RPAS can present a closed list of days through a drop-down list, a clickable calendar, multiple buttons, or other means. The closed list of days presented to the restaurant owner can correspond to the days of the week in the time window filter 174. In this way, the restaurant owner is prompted to register information in a closed format that matches the categories of information that are presented by the RPAS to a potential customer who is looking for a particular promotion, and matches the categories of information filtered by the RPAS for a potential customer who is looking for a particular promotion.

A restaurant owner can be presented with an input field for selecting the start time and the end time for the time window when the promotion is available. As shown in FIG. 8, the time input field 840 can allow for specific times of day, and can include options such as “all day.” The RPAS can present an open field for entering time, or a drop-down menu of possible times that can include “from open” and “until close”, a scrollable set of time numbers, or other means for entering a start time and/or an end time. The time entry options for start time and end time presented to the restaurant owner can allow the promotion start time and end time to be filtered by the time window filter 174. In this way, the restaurant owner is prompted to register information in a closed format that matches the way information is presented and filtered by the RPAS for a potential customer who is looking for a particular promotion.

A restaurant owner can be presented with an input field for a more detailed description of the promotion. As shown in FIG. 8, description input field 850 can present a restaurant owner with a space to enter a description of the promotion. In various embodiments, the description can have a fixed number of characters, so that the detailed description can correspond to, and fit within the area for a promotion description 134 on a tile 120.

A method for registering a promotion by a restaurant owner using the Restaurant Promotion and Advertising System may include receiving restaurant owner authentication credentials through a login interface, verifying the restaurant owner's authority to manage promotional content for a specific restaurant, and displaying a restaurant owner dashboard interface on a graphical user interface. The method may include presenting the restaurant owner with a day-by-day promotion management interface displaying each day of the week with indicators showing the number of promotions currently registered for each day. The method may include receiving a restaurant owner selection of a specific day of the week for which to register a new promotion. The method may include displaying a promotion registration interface in response to the restaurant owner's day selection, the promotion registration interface providing structured input fields for entering promotion information. The method may include presenting the restaurant owner with a promotion type input field displaying closed-choice options for categorizing the promotion, the promotion types including food, drink, and event categories that correspond to the promotion type filter options available to customers. The method may include receiving a restaurant owner selection of at least one promotion type from the closed-choice options. The method may include presenting the restaurant owner with a title input field for entering a short description of the promotion, the title input field having a character limit that ensures the entered title will fit within a promotion title display area on restaurant tiles displayed to customers. The method may include receiving a restaurant owner-entered promotion title through the title input field. The method may include presenting the restaurant owner with a day selection input field displaying closed-choice options for days of the week, the day selection input field enabling selection of one or more days when the promotion is available and supporting the creation of recurring weekly promotions. The method may include receiving a restaurant owner selection of at least one day of the week through the day selection input field. The method may include presenting the restaurant owner with a time window input field for specifying start and end times when the promotion is available during the selected days, the time window input field including dropdown selectors with preset options including all-day availability and specific time selections for time-limited promotions. The method may include receiving restaurant owner-entered start and end times through the time window input field. The method may include presenting the restaurant owner with a detailed description input field for entering comprehensive information about the promotion, the detailed description input field having a character limit that ensures the entered description will fit within a promotion description display area on restaurant tiles. The method may include receiving a restaurant owner-entered detailed description through the detailed description input field. The method may include receiving a restaurant owner submission of the entered promotion information. The method may include processing the submitted promotion information without requiring community verification, the processing including storing the promotion information in a restaurant promotion database and associating the promotion with the restaurant owner's establishment. The method may include making the promotion information immediately available for display to customers without an unverified status indicator, enabling real-time dissemination of restaurant owner-registered promotional information with immediate credibility. The method may include automatically displaying the registered promotion to customers when the current time falls within the specified time window and the customer's filter criteria match the promotion type and day selections, enabling real-time promotional visibility to customers in the geographic area. The method may include enabling the restaurant owner to designate the promotion as a recurring weekly promotion that automatically appears on the specified days every week without requiring repeated data entry, reducing the ongoing effort required to maintain promotional presence within the system.

As explained above and shown in FIG. 8, the RPAS can allow a restaurant owner to register information about promotions that future customers can easily filter and sort to find desired promotion information quickly, without the need for the RPAS to have human employees or data managers. This allows the information about promotions to be available quickly, in real time, to future potential customers. By collecting data directly from the restaurant owners about their particular restaurant, and having those restaurant owners submit the promotion information in a format that can be quickly filtered and sorted by future potential customers, without the need for any employees of the RPAS to handle, enter, sort, or process the promotion information, the RPAS is able to provide real-time information to future potential customers that can include pop-up specials or other promotions that may only exist for a short time such as a couple of hours around a single mealtime on a single day. This allows potential customers to find and enjoy local promotions at local restaurants within a time frame that allows for the potential customer to research, travel, and enjoy the meal all within the time window of a current promotion.

It should be clear that there can be at least two pathways for restaurants and their promotions to be included on the RPAS. In a first pathway, individual customers can submit a restaurant's promotions to the RPAS, and other customers can verify the promotions that were submitted by the first listing customer. In this way, the data is verified to ensure accuracy, and customers are rewarded for listing new specials to ensure that more promotions are listed. In the second pathway, restaurant owners can maintain a subscription to submit their own promotions, and can optionally exclude customers from submitting or influencing the promotions for that restaurant.

The RPAS can also allow a restaurant owner to use the platform in the same way as customers, so that the RPAS can provide the restaurant owner with all of the information that can be provided to customers. The RPAS can provide restaurant owners with valuable insights into promotions being offered by other local restaurants. This visibility into the competitive landscape can help restaurant owners make more informed decisions about their offerings. For example, two neighboring restaurants might avoid running “Trivia Tuesday” on the same night, ensuring more diverse options for patrons. In addition, instead of relying on social media platforms to monitor competitor activities, restaurants could explore specials and events in other cities to get inspiration for promotions that may be successful in their own market. This competitor landscape tool not only aids restaurants in fine-tuning their strategies but also enhances the diversity of options available to customers, creating a win-win for both parties.

In various embodiments, customers and/or restaurant owners can submit promotion information by uploading images containing unstructured data, such as screenshots or photos of restaurant specials. Those images can then be processed through a text recognition system. Data can then be extracted from the images, and the data can be parsed into the same closed, predefined fields such as title, type, time window, and descriptions that are used to display and/or filter the information for customers. The new information can then be added to the RPAS and presented to customers.

In various embodiments, machine learning can be used to parse the information in the images. The system can continuously improve the accuracy of the machine learning by incorporating the corrected data provided by users. This process can retrain the machine learning to adapt its recognition and parsing systems, thereby improving over time without requiring manual intervention.

This system can include a feedback loop, where user-provided corrections are continuously integrated into the system's machine learning model. This process enables the system to refine its data extraction capabilities over time, thereby improving accuracy and reliability.

This allows the seamless transition from unstructured image data to verified, structured inputs through a user-friendly process. The inclusion of real-time user verification can ensure high data accuracy, while the automated learning process can enable the system to progressively enhance its performance. This process can reduce the need for manual data entry and can enable precise, up-to-date submissions of time-sensitive and location-specific promotions.

In various embodiments, an RPAS can include a heat map function. A heat map can show how popular or how crowded various restaurants are. The RPAS can collect the GPS locations of all current app users. The RPAS can then use that information to determine how many customers are currently customers in each of the restaurants that are enrolled in the heat map service. In various embodiments, the heat map can include all RPAS users who are within a predetermined distance, such as a 20-meter radius of a restaurant as being customers of that restaurant.

A heat map can then show an indication of the number of customers who are in each restaurant, in real time. For example, in various embodiments, the heat map can display different colors showing the number of known patrons in each restaurant. In various embodiments the heat map can display different colors showing the estimated density of customers in each restaurant. Estimated density can be determined by the number of known patrons in the establishment divided by the number of tables in an establishment. Estimated density can be determined by the number of known patrons in the establishment divided by the square footage of the restaurant. Estimated density can be determined by combining anonymous data from customers who are currently using the application with third-party generic data. In various embodiments, a potential customer may be able to toggle between various different heat maps showing different determinations of how busy each restaurant is, also referred to as restaurant density. This approach provides a comprehensive understanding of a restaurant's appeal, reflecting both active engagement and broader public interest.

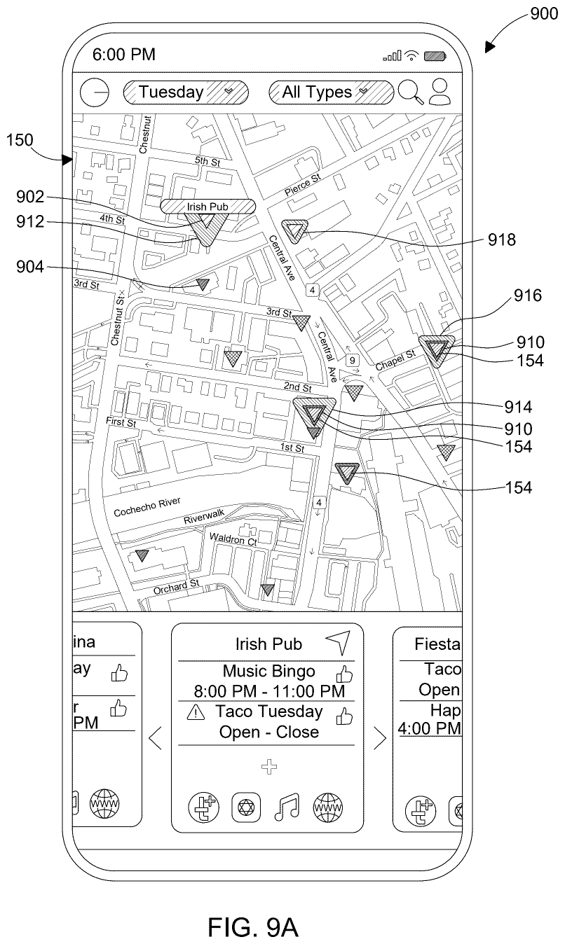

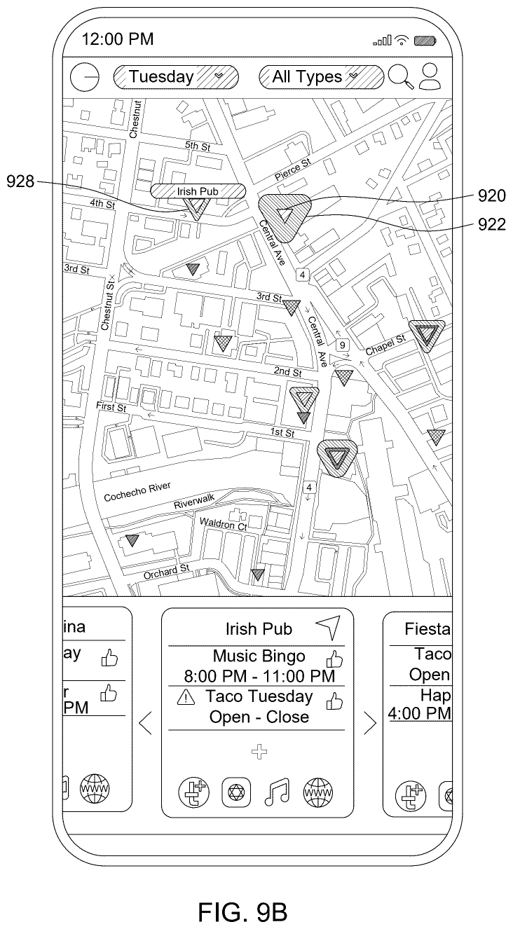

The RPAS can also display the heat map data as part of map 150, so that a customer can see the density information at the same time the customer is seeing information about available promotions. This helps customers to be aware of where other people are, and also aware of why those places are popular. FIG. 9A is a representative view of a heat map overlay for a RPAS, according to an illustrative embodiment. In various embodiments, a heat map 900 can be an additional feature of map 150. The heat map can be displayed as part of map 150 along with various other RPAS information also displayed on map 150. In various embodiments, a heat map can display restaurant density information in the size of a restaurant's tag 154. As restaurant density increases, the size of the restaurant's tag can increase. Restaurants with low density can have a smaller tag 154, while restaurants with higher density can have a larger tag 154.

In various embodiments, the restaurant's density can be displayed by the size of a border 910 around the tag 154. As shown in FIG. 9A, the Irish Pub, displayed by tag 902, has a wide density border 912. In various embodiments, the more people in a restaurant, the wider the density border can be. That is to say, a wider density border, such as density border 912 around the Irish pub, indicates that more people are at that restaurant, and that restaurant has a higher density, compared to a restaurant with a narrower border. As shown in FIG. 9A, a narrow border 918 indicates fewer customers, and a less densely populated restaurant. In various embodiments, density can be relative, and can depend on the total number of customers within the geographic area, however, restaurants with relatively lower density than other restaurants in the geographic area can have a narrow border 918, while restaurants with relatively higher density than other restaurants in the geographic area can have a wider border 912. A restaurant with no customers can be indicated by a tag no density border, such as tag 904. A wide range of border widths are possible, reflecting the wide range of possible density levels within various restaurants. In various embodiments, the widest border 912 can indicate the most dense restaurants, the narrowest border 918 can indicate the least dense restaurants, and restaurants with densities in a middle range can have border widths in a middle range, such as borders 914 and 916.

The heat map system can include a time-based threshold. In various embodiments, a customer may not be counted in a restaurant's density unless that customer stays at that restaurant for a predetermined period of time, such as 30 minutes. This avoids false indicators of popularity from transient users, ensuring that restaurants are flagged as truly popular based on meaningful engagement and not just foot traffic passing by.

FIG. 9B is a representative view of a heat map overlay for a RPAS at a different time of day, according to an illustrative embodiment. Turning to FIGS. 9A and 9B, the heat map can be constantly updated in real time, to reflect the movement of customers in and out of an establishment. FIG. 9A is a representative view of a heat map in the evening, while FIG. 9B is a representative view of a heat map around lunchtime. In FIG. 9B, a popular lunch restaurant 920 is shown with a wide density border 922. Although the Irish Pub is shown with a high density and a wide density border 912 in the evening in FIG. 9A, the Irish Pub is shown with a low density and a narrow density border 928 in the afternoon in FIG. 9B.

It should be clear that tag sizes and/or density borders are only two options out of many possible options for displaying restaurant density as part of map 150. Other possible options could include deeper or lighter colors for tags, contour lines, three-dimensional height displays, or other various options.

In various embodiments, an RPAS can provide real-time information about the density of customers in a restaurant. In various embodiments, restaurant density information can be displayed visually using a heat map. In various embodiments, a heat map can be part of map 150, and the density information can be displayed along with other restaurant information, restaurant location, promotion information, carousel tiles, and/or various other information displayed at the same by an RPAS.

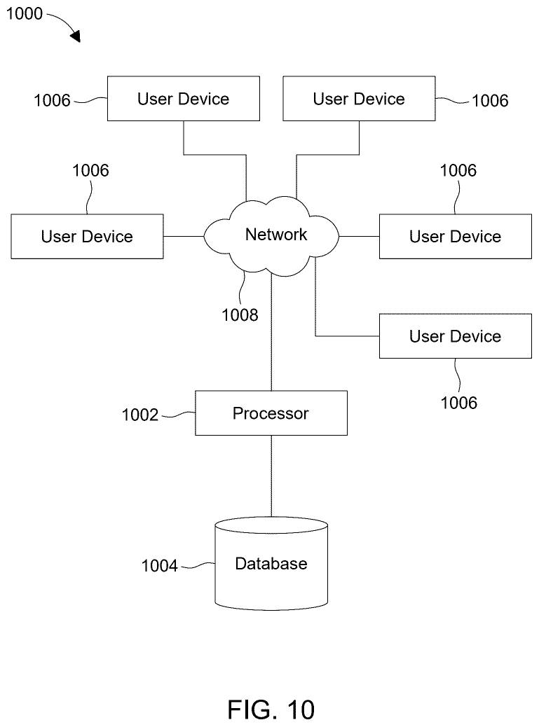

FIG. 10 is a schematic computing system environment for a RPAS, according to an illustrative embodiment. The RPAS computing environment 1000 depicted in FIG. 10 is intended merely as a simplified example to facilitate the description of the present disclosure, and is not intended to be limiting. Embodiments of the system can include various general purpose or special purpose computing system environments. Various examples of computing systems, environments, and/or configurations that may be suitable for use with embodiments of the present invention include, by way of example only, personal computers, server computers, hand-held or laptop devices, multiprocessor systems, microprocessor-based systems, programmable consumer electronics, network PCs, minicomputers, mainframe computers, cell phones, tablets, distributed computing environments that include any of the above-mentioned systems or devices, and the like.

Embodiments of the present invention may be described in the general context of computer-readable and computer-executable instructions stored in non-transitory medium, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, non-transitory memory storage devices.

The exemplary RPAS computing system environment 1000 can include a general-purpose computing device in the form of a RPAS processor 1002. The RPAS processor 1002 can include various modules stored in non-transitory memory and input/output connections to various system components. The RPAS computing system environment can include a data storage unit 1004, such as a database that can be used to store restaurant information, restaurant promotion information, customer information, and other data necessary for system operation.

As used herein, users can include customers and/or restaurant owners. Individual users can have user devices 1006. User devices 1006 can be cell phones, laptops, personal computers, tablets, cars with interface screens, or any other appropriate computing device. User devices 1006 can include various forms of user interfaces including a display screen, a keyboard, a touch screen, a mouse, verbal input microphones, audio output speakers, and/or various user interfaces that may exist currently or be invented in the future. User devices 1006 can be connected to the RPAS processor 1002 through a communication network 1008. Communication network 1008 can include various means by which computing devices can communicate with each other, including but not limited to, the World Wide Web, WIFI, Cellular data service, and various other means for communication that may exist now or may be invented in the future, as will be known to persons of skill in the art. The network connection enables real-time data exchange, which is fundamental to the system's ability to provide current promotion information and allow immediate updates from restaurant owners.

Users can use the user devices 1006 to connect to the RPAS processor 1002 through a network 1008, and the RPAS can be accessed on the user devices 1006. Users can connect to the RPAS processor to access information from the RPAS that may be stored in the database 1004, and the information of the PRAS can be accessed on the user devices 1006. Users can connect to the RPAS processor to provide information to the PRAS that may be stored in the database 1004, and the information can be provided to the RPAS through the user devices.

The distributed architecture shown in FIG. 10 enables the RPAS to serve multiple users simultaneously while maintaining data consistency and real-time functionality. When customers use their user devices 1006 to search for restaurant promotions in their geographic area, processor 1002 retrieves relevant information from database 1004 and delivers it through network 1008. Similarly, when restaurant owners update their promotions, the changes are immediately stored in database 1004 and made available to all customers accessing the system.

This computing environment supports the community-driven verification system described elsewhere in the application, where multiple users can contribute and verify restaurant information. The centralized processor 1002 and database 1004 manage the authentication points and trust scores for users, while the distributed user devices 1006 allow the community to participate in maintaining accurate, up-to-date information about local restaurant promotions.

This system architecture provides scalability to handle varying numbers of users and restaurants, while the real-time communication capabilities ensure that time-sensitive promotions and events can be immediately communicated to potential customers in the relevant geographic areas.

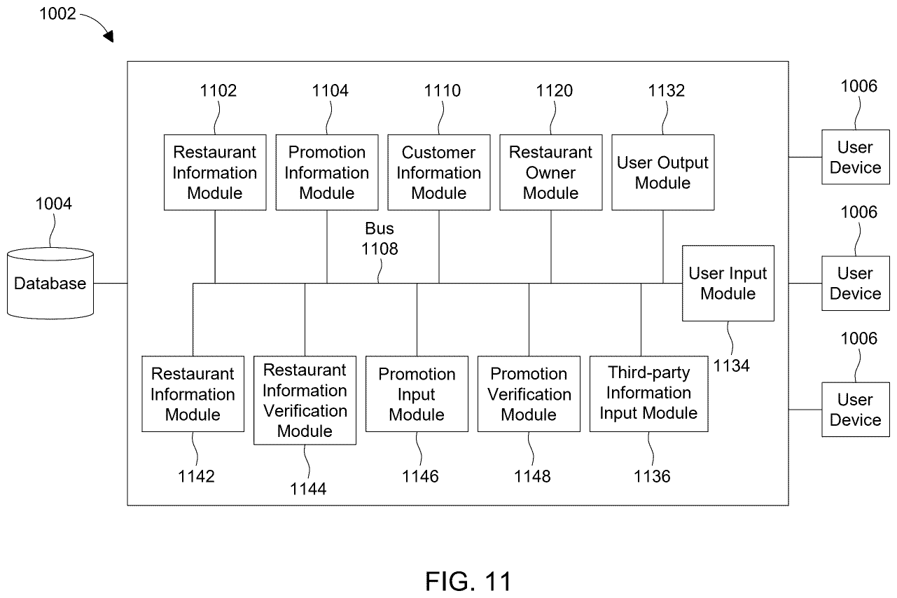

FIG. 11 is a schematic processing environment for a RPAS, according to an illustrative embodiment. his figure shows the detailed internal architecture of processor 1002 from FIG. 10, revealing how the various functional modules interconnect and operate together to provide the comprehensive restaurant promotion system functionality. A processor 1002 can include various modules that can be connected by a bus 1108. The processor can include a restaurant information module 1102 and a restaurant promotion information module 1104. The restaurant information module 1102 can maintain restaurant information, such as restaurant name, address, geolocation information, hours of business, size, and/or other possible static information about a restaurant. Information maintained by the restaurant information module 1102 generally remains constant unless the restaurant makes a change to the business, such as changing the business hours.

The restaurant promotion module 1004 can keep track of the various promotions at each restaurant. The restaurant promotion module can keep track of promotion information including, but not limited to, the restaurant that has each promotion, the promotion types, time windows including hours of the day and days of the week, promotion titles, promotion descriptions, and/or other promotion information.

The processor 1002 can include a customer information module 1110. The customer information module can keep track of customer information including, but not limited to, customer email address, customer login, password, trust score, reward point totals, dining preferences, and/or other customer information. Dining preferences can include preferred types of foods, preferred types of promotions, and/or other preference information.

The processor 1002 can include a restaurant owner module 1120. The restaurant owner module can keep track of restaurant owner information including, but not limited to, the restaurant owner's subscription information, login, password, saved promotions, historical promotions, and/or other restaurant owner information. The restaurant owner module 1120 can keep track of the various employee's login credentials and passwords, various authority levels, permissions assigned to each employee and/or assigned to each authority level, and/or various other information about different login accounts with access to the restaurant owner subscription.

The processor 1002 can include a user output module 1132. The user output module 1132 can provide information to user devices 1006 in response to requests from the user devices for information about restaurants and restaurant promotions. The user output module 1132 can provide restaurant information and restaurant promotion information to the user devices 1006 in response to requests for information from the user devices. The user output module 1132 can update the information provided to the user devices 1006 in response to updated requests for information from the user devices 1006. Updated requests for information can include revised geographic areas, revised time windows, and/or other changes to the requested information.

The processor 1002 can include a user input module 1134. The user input module can receive information from the user devices 1006 about restaurants and/or restaurant promotions.

The processor 1002 can include a restaurant information input module 1142. The restaurant information input module 1142 can receive information through the user input module 1134 from the user devices 1006 regarding restaurants. Information received by the restaurant information input module 1142 that came from a restaurant owner regarding that restaurant's information can be input to the restaurant information module 1102, and the restaurant information module can add a new restaurant and/or update the restaurant information as provided by the restaurant owner.

Information received by the restaurant information input module 1142 that came from a customer regarding any restaurant's information can be input to the restaurant information verification module 1144. The restaurant information verification module can provide the unverified restaurant information to other user devices 1006 through the user output module 1132, so that verifying customers can be informed about restaurant information that needs verification. As verifying customers provide verification regarding the restaurant information, that verification can be input by the user input module 1134 and provided to the restaurant verification module 1144. The restaurant verification module can receive trust score information for the recording customer and verifying customer from the customer information module, and the restaurant verification module can assign authentication points to the new or revised restaurant information. When the new or revised restaurant information reaches a predetermined number of authentication points, the restaurant verification module can verify the new or revised restaurant information. When the new or revised restaurant information is verified, the restaurant information verification module can output the new or revised restaurant information to the restaurant information module 1120 so that the restaurant information module can include the new or revised restaurant information.

The processor 1002 can include a promotion information input module 1146. The promotion information input module 1146 can receive information through the user input module 1134 from the user devices 1006 regarding restaurants. Information received by the promotion information input module 1146 that came from a restaurant owner regarding that restaurant's promotion information can be input to the restaurant promotion module 1104, and the restaurant promotion module can add a new promotion and/or update the promotion information for that restaurant as provided by the restaurant owner.

Information received by the promotion information input module 1146 that came from a customer regarding any restaurant's promotion information can be input to the promotion verification module 1148. The promotion verification module can provide the unverified promotion information to other user devices 1006 through the user output module 1132, so that verifying customers can be informed about promotion information that needs verification. As verifying customers provide verification regarding the promotion information, that verification can be input by the user input module 1134 and provided to the promotion verification module 1148. The promotion verification module can receive trust score information for the recording customer and verifying customer from the customer information module, and the promotion verification module can assign authentication points to the new or revised promotion information. When the new or revised promotion information reaches a predetermined number of authentication points, the promotion verification module can verify the new or revised promotion information. When the new or revised promotion information is verified, the promotion verification module can output the new or revised promotion information to the restaurant promotion information module 1104 so that the promotion information module can add a new promotion and/or update the promotion information for that restaurant as provided by the promotion verification module.

The processor 1002 can include a third-party restaurant information input module 1336. The third-party restaurant information input module can input information from various third-party business listings, including third party map services and/or other third-party listings of existing businesses. Information from third party sources that is input through the third-party information input module can be provided to user devices 1006 through the user information output module 1132.

This modular architecture enables the RPAS to maintain data accuracy through community verification while providing real-time access to restaurant and promotion information. The interconnected modules work together to support both the customer-facing features for discovering promotions and the restaurant owner tools for managing promotional content, creating a comprehensive platform that serves all user types effectively.

Although this invention has been disclosed in the context of certain preferred embodiments and examples, it therefore will be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

Some embodiments, illustrating its features, will now be discussed in detail. The words “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, in various embodiments, the restaurant information and restaurant promotion information described herein can be presented in any number of different formats in addition to, or different from, the information display formats described herein. Also, as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 5%) of the system. Note also, as used herein the terms “process” and/or “processor” should be taken broadly to include a variety of electronic hardware and/or software-based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. A method for displaying real-time restaurant promotional information, the method comprising:
determining a geographic location of a mobile communication device operated by a user;
displaying a map representation of an area around the mobile communication device on a graphical user interface of the mobile communication device;
superimposing on the map a plurality of location markers, each location marker corresponding to a restaurant within the area; and
displaying a carousel interface on the graphical user interface, the carousel interface containing a plurality of tiles, each tile corresponding to one of the restaurants represented by the location markers on the map.

2. The method of claim 1, further comprising:
receiving a filter criterion from the user, the filter criterion specifying at least one of a time window and a promotion type;
filtering the plurality of restaurants based on the filter criterion to identify restaurants having promotions matching the filter criterion; and
updating a visual appearance of the location markers on the map to indicate which restaurants have promotions matching the filter criterion.

3. The method of claim 2, wherein receiving a filter criterion from a user specifying the time window further comprises receiving a day of the week selection and a time of day range.

4. The method of claim 2, wherein receiving a filter criterion from a user specifying the promotion type further comprises receiving at least one of a food promotion, a drink promotion, and an event promotion.

5. The method of claim 2, wherein updating the visual appearance of the location markers includes displaying location markers in different colors based on whether corresponding restaurants have promotions matching the filter criterion.

6. The method of claim 1, further comprising:
receiving a selection input from the user identifying a selected restaurant;
highlighting the location marker for the selected restaurant with a prime tag on the map;
simultaneously displaying a tile for the selected restaurant in a prime position of the carousel interface; and displaying promotional information for the selected restaurant on the tile in the prime position, the promotional information including a promotion title, a time window during which a promotion is available, and a description of the promotion.

7. The method of claim 6, wherein updating the visual appearance of the location markers includes displaying location markers in different colors based on whether corresponding restaurants have promotions matching the filter criterion.

8. The method of claim 1 further comprising:
displaying a customer location indicator on the map showing the geographic location of the mobile communication device; and
determining a distance between the customer location and each restaurant for display on the corresponding tile.

9. The method of claim 1, further comprising:
receiving a second selection input from the user identifying a second selected restaurant different from the selected restaurant;
removing the prime tag from the location marker for the selected restaurant;
highlighting the location marker for the second selected restaurant with the prime tag on the map;
removing the tile for the selected restaurant from the prime position of the carousel interface; and
simultaneously displaying a tile for the second selected restaurant in the prime position of the carousel interface.

10. A method for recording restaurant promotional information through community contribution, the method comprising:
receiving a customer indication to record a new promotion for a restaurant;
displaying a promotion input interface on a graphical user interface of a mobile communication device;
presenting a promotion type input field displaying closed-choice options for categorizing the promotion;
receiving a customer selection of at least one promotion type from the closed-choice options;
presenting a day selection input field displaying closed-choice options for days of the week;
receiving a customer selection of at least one day of the week through the day selection input field;
presenting a time window input field for specifying start and end times when the promotion is available;
receiving customer-entered start and end times through the time window input field;
presenting a description input field for entering information about the promotion;
receiving a customer-entered description through the description input field; and
receiving a customer submission of the entered promotion information.

11. The method of claim 10, wherein presenting a promotion type input field displaying closed-choice options further comprises presenting the closed-choice options for promotion type that include food, drink, and event categories.

12. The method of claim 10, further comprising:
processing the submitted promotion information by assigning initial authentication points based on a trust score of a recording customer;
making the promotion information immediately available for display to other customers with an unverified status indicator; and
initiating a community verification process for the submitted promotion.

13. The method of claim 12, wherein initiating the community verification process comprises:
displaying the promotion information to verifying customers with the unverified status indicator;
receiving verification responses from verifying customers;
assigning additional authentication points based on trust scores of the verifying customers; and
removing the unverified status indicator when accumulated authentication points reach a predetermined threshold.

14. The method of claim 13, further comprising:
increasing the trust score of the recording customer when the submitted promotion is verified by other customers; and
awarding reward points to the recording customer for submitting the promotion information.

15. The method of claim 12, wherein initiating the community verification process comprises:
receiving a verification response indicating that promotion details are incorrect;
presenting a promotion correction interface to a correcting customer;
receiving corrected promotion information through the promotion correction interface; and
updating the promotion information based on the corrected promotion information.

16. A method for displaying restaurant density information, the method comprising:
determining geographic locations of a plurality of mobile communication devices 2 operated by users within an area;
displaying a map representation of the area on a graphical user interface of a mobile communication device;
superimposing on the map a plurality of location markers, each location marker corresponding to a restaurant within the area;
determining a number of users currently located within a predetermined radius of each restaurant based on the geographic locations of the plurality of mobile communication devices;
calculating a density value for each restaurant based on the determined number of users;
displaying a density indicator for each restaurant on the map, the density indicator having a visual appearance that varies based on the calculated density value; and
updating the density indicators in real-time as the geographic locations of the plurality of mobile communication devices change.

17. The method of claim 16, wherein displaying a density indicator further comprises displaying a border surrounding the location marker, the border having a width that increases with increasing density value.

18. The method of claim 16, further comprising:
determining whether each user has remained within the predetermined radius of a restaurant for a predetermined time period; and
counting only users who have remained within the predetermined radius for the predetermined time period toward the number of users currently located at the restaurant.

19. The method of claim 16, wherein calculating the density value comprises dividing the number of users currently located within the predetermined radius by at least one of a number of tables at the restaurant and a square footage of the restaurant.

20. The method of claim 16, further comprising displaying promotional information for restaurants on a carousel interface synchronized with the map; and simultaneously displaying both the density indicator and promotional information for a selected restaurant.
